(19) United States
(12) Patent Application Publication
(10) Pub. No.: US 2019/0051155 A1
(43) Pub. Date: Feb. 14, 2019

(54) INFORMATION NOTIFICATION APPARATUS, INFORMATION NOTIFICATION SYSTEM, INFORMATION NOTIFICATION METHOD, AND INFORMATION NOTIFICATION PROGRAM

(71) Applicant: TOYOTA JIDOSHA KABUSHIKI KAISHA, Toyota-shi (JP)

(72) Inventor: Tomonari YAMAGUCHI, Tokyo (JP)

(73) Assignee: TOYOTA JIDOSHA KABUSHIKI KAISHA, Toyota-shi (JP)

(21) Appl. No.: 16/057,181

(22) Filed: Aug. 7, 2018

(30) Foreign Application Priority Data
Aug. 10, 2017 (JP) 2017-155300

(51) Int. Cl. G08G 1/01; G08G 1/0965; G08G 1/0968; G01C 21/36

(52) U.S. Cl. CPC G08G 1/0133; G08G 1/012; G08G 1/0965; H04W 4/44; G01C 21/3691; G01C 21/3667; G08G 1/096811

(57) ABSTRACT

An information notification apparatus includes a vehicle information obtaining unit configured to obtain vehicle information regarding movement states of a plurality of vehicles, a congestion potential deriving unit configured to derive congestion potential indicating that congestion is to occur on a surrounding road in the future due to vehicles parked in a predetermined area based on the vehicle information, and a controller configured to notify a user of information regarding the congestion potential through a notification unit provided in a portable terminal or a target vehicle.

### INCORPORATION BY REFERENCE

The disclosure of Japanese Patent Application No. 2017-155300 filed on Aug. 10, 2017 including the specification, drawings and abstract is incorporated herein by reference in its entirety.

### BACKGROUND

### 1. Technical Field

The disclosure relates an information notification apparatus, an information notification system, an information notification method, and information notification program.

### 2. Description of Related Art

In the related art, a technology in which an event such as a vehicle failure is set as a congestion occurrence factor in a specific location of a target road, a traffic situation such as congestion occurrence is predicted through microsimulation, and information regarding the traffic situation is notified to a user has been known (for example, see Japanese Unexamined Patent Application Publication No. 2010-67180 (JP 2010-67180 A)).

### SUMMARY

However, in JP 2010-67180 A, parked vehicles are not considered. Thus, information regarding congestion which is likely to occur when many vehicles parked in a certain area enter a road at the same time in the future may not be notified to the user.

The disclosure provides an information notification apparatus, an information notification system, an information notification method, and an information notification program which can notify a user of information regarding future congestion which is likely to occur due to parked vehicles.

A first aspect of the disclosure relates to an information notification apparatus including a vehicle information obtaining unit configured to obtain vehicle information regarding movement states of a plurality of vehicles, a congestion potential deriving unit configured to derive congestion potential indicating that congestion is likely to occur on a surrounding road in the future due to vehicles parked in a predetermined area based on the vehicle information, and a controller configured to notify a user of information regarding the congestion potential through a notification unit provided in a portable terminal or a target vehicle.

According to the first aspect of the disclosure, the information notification apparatus can ascertain the movement states of the vehicles from the vehicle information obtained from the vehicles. Thus, the information notification apparatus can ascertain the parked vehicles of the area by monitoring that the number of vehicles leaving the predetermined area is considerably smaller than the number of vehicles entering the predetermined area or there are more vehicles parked in the predetermined area than usual. The information notification apparatus can derive risk potential (congestion potential) indicating that congestion is likely to occur on a surrounding road when the vehicles (that is, the parked vehicles) staying within the area enter the road in the future. Accordingly, the information notification apparatus can notify the user of the information regarding the congestion potential as the information regarding the future congestion which is likely to occur due to the parked vehicles through the notification unit of the vehicle 10.

In the information notification apparatus according to the first aspect of the disclosure, the controller may display the information regarding the congestion potential on a display device as the notification unit.

According to the first aspect of the disclosure, the information notification apparatus can notify the user of the information regarding the congestion potential through the display device mounted on the portable terminal or the target vehicle.

In the information notification apparatus according to the first aspect of the disclosure, the controller may display a map image on the display device, and may display an image object having a size corresponding to a magnitude of the congestion potential in a position of the map image corresponding to the area having the congestion potential so as to superimpose the image object on the map image.

According to the first aspect of the disclosure, the information notification apparatus can allow the user of the portable terminal or the target vehicle to easily ascertain the specific position of the area having high congestion potential to some extent and the degree of congestion potential by the position and size of the image object on the map image.

In the information notification apparatus according to the first aspect of the disclosure, the vehicle information obtaining unit may obtain parking position information regarding a position when each of the vehicles is parked, as the vehicle information, and the congestion potential deriving unit may derive the congestion potential based on the number of vehicles parked within the area, among the vehicles, which is calculated based on the parking position information.

According to the first aspect of the disclosure, the information notification apparatus can ascertain the number of vehicles which are likely to enter the surrounding road of the area in the future by calculating the number of parked vehicles in the predetermined area from the parking position information of the vehicles. Accordingly, the information notification apparatus can specifically derive the congestion potential indicating that the congestion is likely to occur on the surrounding road of the area when the parked vehicles enter the road from the number of vehicles parked within the area.

The information notification apparatus according to the first aspect of the disclosure may further include a parking time information obtaining unit configured to obtain parking time information regarding a time during which each of the vehicles is parked, a departure timing predicting unit configured to predict a departure timing for each vehicle parked in the area, among the vehicles, based on a history of the parking time information, and a congestion occurrence timing predicting unit configured to predict a timing when the congestion is to occur depending on the congestion potential based on the departure timing predicted by the departure timing predicting unit. The controller may notify the user of information regarding the timing when the congestion is to occur, which is predicted by the congestion occurrence timing predicting unit, through the notification unit.

According to the first aspect of the disclosure, the information notification apparatus can predict the current parking time of each vehicle staying in the predetermined area, in other words, the departure timing from the history of the parking time information for each vehicle. The information notification apparatus can predict a timing when each parked vehicle enters the road from the predicted departure timing of the parked vehicle.

Accordingly, the information notification apparatus can predict the timing when the congestion is to occur depending on the congestion potential by specifying the timing when the parked vehicles of the area intensively enter the road, and can notify the user of the predicted timing together with the derived congestion potential through the notification unit provided in the vehicle.

In the information notification apparatus according to the first aspect of the disclosure, the departure timing predicting unit may predict the departure timing for each vehicle parked in the area, among the vehicles, based on the history of the parking time information regarding the time during which the vehicle is parked when the vehicle visits a point of interest (POI) belonging to the same genre as a genre of a POI corresponding to the area for each of the vehicles.

According to the first aspect of the disclosure, since parking times are different from each other depending on genres of locations visited, the information notification apparatus uses the history of the parking time information when the vehicle visits the POI having the same genre as the genre of the POI corresponding to the predetermined area,. Accordingly, since the information notification apparatus can predict the departure timing of each parked vehicle within the area with higher precision, the information notification apparatus can consequently predict the timing when the congestion is to occur depending on the congestion potential with high precision.

The information notification apparatus according to the first aspect of the disclosure may further include a usual congestion information obtaining unit configured to obtain usual congestion information regarding a usual congestion situation, and a congestion level predicting unit configured to predict a congestion level of the congestion that is likely to occur depending on the congestion potential based on the usual congestion information and the congestion potential. The controller may notify the user of the congestion level predicted by the congestion level predicting unit through the notification unit.

According to the first aspect of the disclosure, the information notification apparatus can predict the congestion level of the congestion which is likely to occur in the predetermined area and on the road surrounding the area by adding the degree of influence depending on the congestion potential to the usual congestion situation based on the usual congestion information. Accordingly, the information notification apparatus can specifically notify the user of the congestion level of the congestion which is likely to occur depending on the congestion potential, in addition to the congestion potential.

The information notification apparatus according to the first aspect of the disclosure may further include a movement history information obtaining unit configured to obtain movement history information regarding a history of positional information and timing information in accordance with movement of each of the vehicles. The usual congestion information obtaining unit may obtain the usual congestion information based on the movement history information.

According to the first aspect of the disclosure, the information notification apparatus can ascertain the usual congestion situation of the road through which each vehicle passes and can obtain the usual congestion information by ascertaining the passing timing or the average vehicle speed when the vehicle passes through the road based on the movement history information.

The information notification apparatus according to the first aspect of the disclosure may further include a route information obtaining unit configured to obtain information regarding a route to a destination of the vehicle on which the user rides. The controller may notify the user of the information regarding the congestion potential of the area through the notification unit irrespective of whether or not a request from the portable terminal or the target vehicle is received when the area having relatively high congestion potential is included in areas on the route or areas adjacent to the route.

According to the first aspect of the disclosure, when the area having relatively high congestion potential is included in the areas on the route of the vehicle on which the user rides or the areas adjacent to the route, the user can be provided with the information regarding the congestion potential of the area with no request. Accordingly, it is possible to improve user convenience.

A second aspect of the disclosure relates to an information notification system that includes a server, and a portable terminal or a target vehicle connected to the server so as to communicate with each other. The information notification system includes a vehicle information obtaining unit provided in the server, and configured to obtain vehicle information regarding movement states from a plurality of vehicles, a congestion potential deriving unit provided in the server, and configured to derive congestion potential indicating that congestion is to occur on a surrounding road in the future due to vehicles parked in a predetermined area based on the vehicle information, and a notification unit provided in the portable terminal or the target vehicle, and configured to notify a user of information regarding the congestion potential.

A third aspect of the disclosure relates to an information notification method performed by an information notification apparatus. The information notification method includes obtaining vehicle information regarding movement states of a plurality of vehicles, deriving congestion potential indicating that congestion is to occur on a surrounding road in the future due to vehicles parked in a predetermined area based on the vehicle information, and notifying a user of information regarding the congestion potential through a notification unit provided in a portable terminal or a target vehicle.

A fourth aspect of the disclosure relates to an information notification program causing a computer to perform a vehicle information obtaining step of obtaining vehicle information regarding movement states of a plurality of vehicles, a congestion potential deriving step of deriving congestion potential indicating that congestion is to occur on a surrounding road in the future due to vehicles parked in a predetermined area based on the vehicle information, and a control step of notifying a user of information regarding the congestion potential through a notification unit provided in a portable terminal or a target vehicle.

According to the aspects of the disclosure, it is possible to provide an information notification apparatus, an information notification system, an information notification method, and an information notification program which are capable of notifying a user of information regarding future congestion which is likely to occur due to parked vehicles.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing an example of a configuration of an information notification system according to the present embodiment;

FIG. 2 is a functional block diagram showing an example of a functional configuration of a vehicle;

FIG. 3 is a functional block diagram showing an example of a functional configuration of a center server;

FIG. 4 is a schematic flowchart showing an example of processing for outputting usual congestion situation which is performed by the center server;

FIG. 5 is a table showing an example of usual congestion information;

FIG. 6 is a schematic flowchart showing an example of processing for outputting home information which is performed by the center server;

FIG. 7 is a table showing an example of home information;

FIG. 8 is a schematic flowchart showing an example of processing for outputting parking time information which is performed by the center server;

FIG. 9 is a schematic table showing an example of parking time information;

FIG. 10 is a schematic flowchart showing an example of processing for outputting parked vehicle information which is performed by the center server;

FIG. 11 is a table showing an example of parked vehicle information;

FIG. 12 is a schematic flowchart showing an example of processing for updating and outputting parked vehicle information which is performed by the center server;

FIG. 13 is a table showing an example of the parked vehicle information updated and output in an aspect in which an expected departure timing is added;

FIG. 14 is a schematic flowchart showing an example of processing for outputting information regarding the number of most recently departed vehicles which is performed by the center server;

FIG. 15 is a table showing an example of the information regarding the number of most recently departed vehicles;

FIG. 16 is a flowchart showing an example of processing for outputting congestion prediction information which is performed by the center server;

FIG. 17 is a graph for describing a method of deriving an expected departure peak timing;

FIG. 18 is a graph for describing a method of correcting the expected departure peak timing;

FIG. 19 is a table showing an example of congestion potential information;

FIG. 20 is a table showing an example of predicted congestion level information;

FIG. 21 is a schematic sequence diagram showing an example of the entire operation of the information notification system;

FIG. 22 is a table showing an example of the congestion potential information returned from a congestion prediction information DB;

FIG. 23 is a table showing an example of the predicted congestion level information returned from a congestion prediction information DB;

FIG. 24 is a schematic sequence diagram showing another example of the entire operation of the information notification system; and

FIG. 25 is a diagram showing an example of a navigation image displayed on a display.

### DETAILED DESCRIPTION OF EMBODIMENTS

Hereinafter, an embodiment for implementing the disclosure will be described with reference to the drawings.

Configuration of Information Notification system

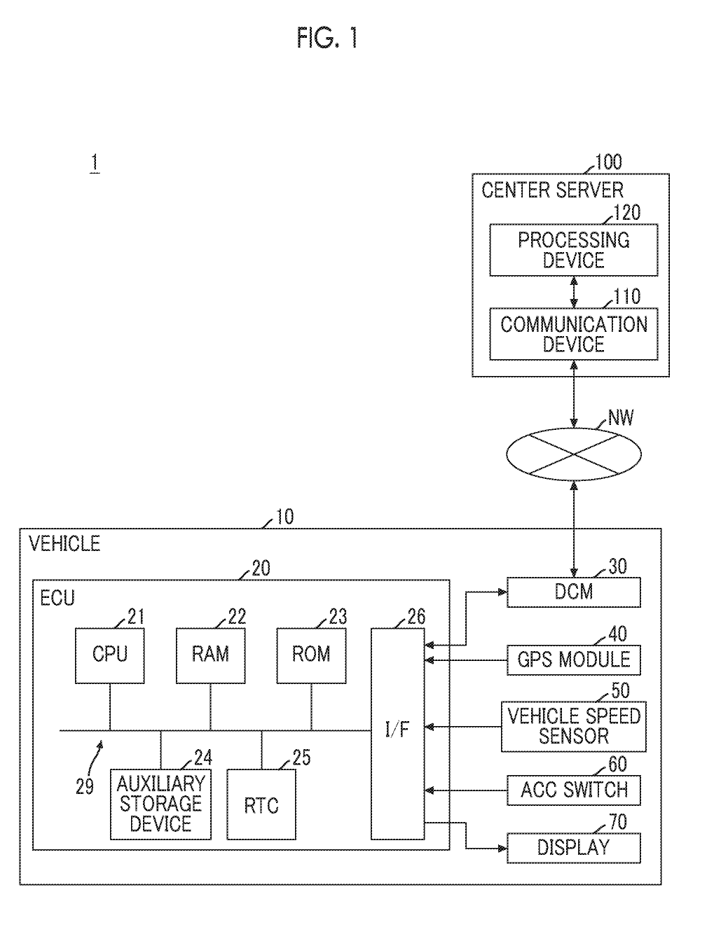

A configuration of an information notification system 1 according to the present embodiment will be described with reference to FIGS. 1 to 3.

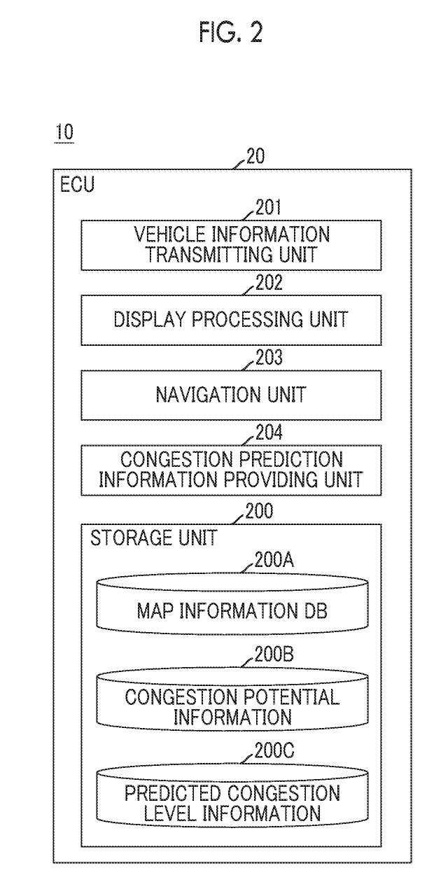

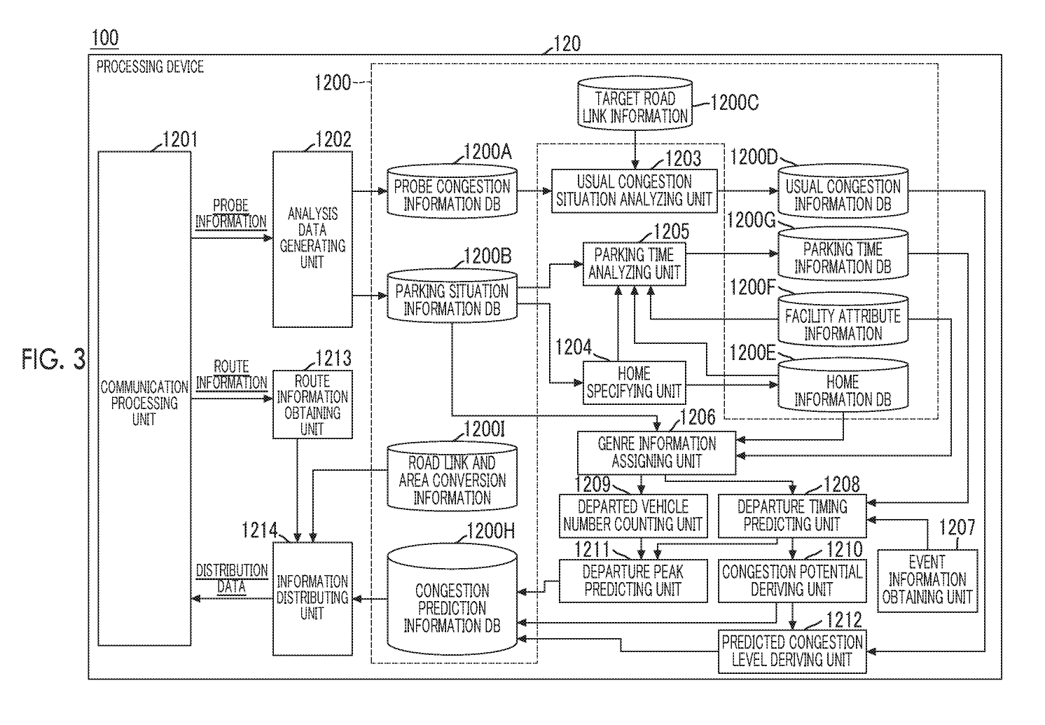

FIG. 1 is a schematic diagram showing an example of the configuration of the information notification system 1 according to the present embodiment. FIG. 2 is a functional block diagram showing an example of a functional configuration of a vehicle 10 according to the present embodiment. FIG. 3 is a functional block diagram showing an example of a configuration of a center server 100 according to the present embodiment.

The information notification system 1 includes a plurality of vehicles 10 and the center server 100 which is connected to the vehicles 10 so as to communicate with each other via a predetermined communication network NW. The information notification system 1 obtains vehicle information indicating traffic situations from the vehicles 10 as probes, predicts future congestion situations, and distributes information (congestion prediction information to be described below) regarding the future congestion situation to the vehicle 10 as a target among the vehicles 10.

One vehicle 10 has the same configuration as another vehicle 10 for the information notification system 1. Thus, one vehicle 10 is representatively depicted in FIG. 1.

The vehicle 10 includes an electronic control unit (ECU) 20, a data communication module (DCM) 30, a global positioning system (GPS) module 40, a vehicle speed sensor 50, an accessory (ACC) switch 60, and a display 70.

The ECU 20 is an electronic control unit that performs control processing related to a predetermined function of the vehicle 10. For example, the ECU 20 obtains vehicle information which includes information regarding a state (vehicle state) of the vehicle 10, information regarding a state (occupant state) of an occupant of the vehicle 10, and information regarding a state (surrounding state) near the vehicle 10 from various sensors, actuators, ECUs, and the like mounted on the vehicle 10. The ECU 20 uploads the obtained vehicle information to the center server 100 through the DCM 30. For example, the ECU 20 performs control processing related to a navigation function of guiding a route to a destination in response to a request from a user or the like.

The function of the ECU 20 may be realized by any hardware, any software, or the combination of any hardware and any software. For example, the ECU 20 is constituted by a microcomputer that includes a central processing unit (CPU) 21, a random-access memory (RAM) 22, a read-only memory (ROM) 23, an auxiliary storage device 24, a real-time clock (RTC) 25, and a communication interface (I/F) 26, which are connected to a bus 29. The ECU 20 includes a vehicle information transmitting unit 201, a display processing unit 202, a navigation unit 203, and a congestion prediction information providing unit 204, as functional units realized by executing one or more programs stored in the ROM 23 or the auxiliary storage device 24. The ECU 20 includes a storage unit 200 as a storage region defined in an internal memory such as the auxiliary storage device 24.

The functions of the ECU 20 may be shared and realized by a plurality of ECUs. Specifically, for example, the function of the vehicle information transmitting unit 201, the function of the display processing unit 202, and the functions of the navigation unit 203 and the congestion prediction information providing unit 204 of the ECU 20 may be realized by different ECUs from one another.

The vehicle information transmitting unit 201 obtains the vehicle information from various sensors, actuators, ECUs, and the like on a regular basis, and transmits probe information including the obtained vehicle information to the center server 100 through the DCM 30. For example, the vehicle information transmitting unit 201 obtains positional information of the vehicle 10 from the GPS module 40. The vehicle information transmitting unit 201 obtains vehicle speed information of the vehicle 10 from the vehicle speed sensor 50. The vehicle information transmitting unit 201 obtains information (ACC-OFF information) indicating that the ACC switch 60 is switched from an ON state to an OFF state and information (ACC-ON information) indicating that the ACC switch 60 is switched from the OFF state to the ON state, based on an output signal of the ACC switch 60. Hereinafter, the ACC-OFF information and the ACC-ON information may be comprehensively referred to as ACC-OFF/ON information. For example, the vehicle information transmitting unit 201 obtains timing information when the vehicle information is obtained from the RTC 25. The vehicle information transmitting unit 201 generates probe information that includes the obtained vehicle information such as the positional information, the vehicle speed information, and the ACC-OFF/ON information of the vehicle 10 and the timing information when the vehicle information is obtained, and transmits the generated probe information to the center server 100 through the DCM 30.

An aspect in which the probe information does not include the timing information when the vehicle information is obtained may be adopted. In this case, the center server 100 may determine that a transmission timing of the probe information in the vehicle 10, a reception timing of the probe information in the center server 100, an estimation timing corresponding to the positional information of the vehicle 10 which is calculated from these timings, or the like is the timing information corresponding to the various vehicle information. Since the ACC-OFF/ON information is output solely when the ACC switch 60 is switched from the OFF state to the ON state or from the ON state to the OFF state as stated above, an aspect in which the ACC-OFF/ON information is transmitted to the center server 100 by using a transmission signal different from the probe information may be adopted. In this case, a predetermined transmission signal including the ACC-OFF/ON information and the timing information corresponding to the ACC-OFF/ON information or the positional information of the vehicle 10 may be transmitted to the center server 100. As described above, for example, when a function of transmitting, as the probe information, the vehicle information other than the ACC-OFF/ON information to the center server 100 is standardized as a function of a predetermined device (for example, a navigation device including the navigation unit 203) mounted on the vehicle 10, even a vehicle in which the device is not provided can transmit the ACC-OFF/ON information or the like to the center server 100. That is, the center server 100 may also obtain the ACC-OFF/ON information or the like from even the vehicle in which the device is not provided. Thus, it is possible to derive the congestion prediction information (congestion potential, expected departure timing, and predicted congestion level) to be described below with higher precision by increasing the scale of data to be collected.

The display processing unit 202 performs control processing for displaying various information images on the display 70. For example, in response to a request from the navigation unit 203, the display processing unit 202 displays map image on the display 70 and displays guidance information regarding the route guidance to the destination such that the guidance information is superimposed on the map image by using a map information DB 200A of the storage unit 200. At this time, the display processing unit 202 displays the map image on the display 70 based on the map information DB 200A stored in the storage unit 200. For example, the display processing unit 202 displays the congestion prediction information (specifically, congestion potential information and predicted congestion level information) to be described below in response to a request from the congestion prediction information providing unit 204.

The function of the display processing unit 202 may be built into the display 70.

The navigation unit 203 searches for a route to a destination from a current location based on the known algorithm. The navigation unit 203 outputs, as the route searching result, one or a plurality of routes, determines a route to be used in the route guidance by a selection operation of the user, and guides the route to the destination from the current location based on the selected route. The navigation unit 203 displays a destination setting screen or displays the map image and a route guidance image such that these images are superimposed on each other on the display 70 through the display processing unit 202 in accordance with the route search and the route guidance. The navigation unit 203 may search for the route and may guide the route based on the destination set by an operation input from the user of the vehicle 10, or may search for the route and may guide the route based on the destination (estimated destination) to be automatically set based on a past movement history of the vehicle 10 or the like.

The congestion prediction information providing unit 204 displays prediction information (congestion prediction information) regarding congestion which is likely to occur in the future on the route corresponding to the route guidance performed by the navigation unit 203 on the display 70 through the display processing unit 202 in cooperation with the function of the navigation unit 203. For example, the congestion prediction information providing unit 204 transmits information (hereinafter, referred to as route information) regarding the route guidance to the center server 100 through the DCM 30. The route information includes road links IDs of road links through which the vehicle passes from the current location to the destination, an expected passing timing when the vehicle passes through the road links, and the like. The congestion prediction information providing unit 204 obtains the congestion prediction information which is received from the center server 100 through the DCM 30 and is stored in the storage unit 200, specifically, congestion potential information 200B and predicted congestion level information 200C. The congestion prediction information providing unit 204 displays an image (congestion prediction image) corresponding to the congestion potential information 200B and the predicted congestion level information 200C such that this image is superimposed on a navigation image (the map image and the route guidance image) displayed on the display 70 by the navigation unit 203 through the display processing unit 202. The details of the operation of the congestion prediction information providing unit 204 will be described below.

For example, the DCM 30 is a communication device that bidirectionally communicates with the center server 100 via the predetermined communication network NW including a cellular phone network in which a plurality of base stations is used as terminals, the Internet, or the like. The DCM 30 is connected to various ECUs including the ECU 20 so as to communicate with each other via an in-vehicular network such as a

### Controller Area Network (CAN).

The GPS module 40 receives GPS signals transmitted from three or more, desirably, four or more satellites in the sky of the vehicle 10, and measures the position of the vehicle 10 on which this GPS module is mounted. The GPS module 40 is connected to the ECU 20 and the like so as to communicate with each other through a one-to-one communication line or an in-vehicular network such as CAN, and the measured positional information of the vehicle 10 is input to the ECU 20 and the like.

The vehicle speed sensor 50 is the known a detection unit for detecting the vehicle speed of the vehicle 10. The vehicle speed sensor 50 is connected to the ECU 20 or the like so as to communicate with each other through a one-to-one communication line or an in-vehicular network such as CAN, and a detection signal (vehicle speed information) corresponding to the vehicle speed of the vehicle 10 is input to the ECU 20 or the like.

The ACC switch 60 turns on or off an accessory power supply of the vehicle 10 in response to a predetermined operation performed by an occupant such as a driver or the like of the vehicle 10. For example, the ACC switch 60 is turned on or off in response to an operation performed for a power switch (a button-type switch for operating the ACC switch 60 and an ignition switch) provided on an instrument panel near a steering wheel of the driver seat within a vehicle cabin of the vehicle 10. The ACC switch 60 is connected to the ECU 20 or the like so as to communicate with each other through a one-to-one communication line or an in-vehicular network such as CAN, and a state signal (ON signal/OFF signal) of the ACC switch 60 is input to the ECU 20 or the like.

The display 70 (a notification unit, an example of a notification unit) displays various information images under the control of the ECU 20 (specifically, display processing unit 202). For example, the display 70 is a liquid crystal display, an electroluminescence (EL) display, or the like, and may be a touch panel type which also serves as an operation unit. The display 70 is provided at a portion, for example, a top portion near the center of the instrument panel in a right-left direction so as to be easily perceived by the user within the vehicle cabin of the vehicle 10, particularly, the driver. The display 70 may be used solely for displaying the navigation image or the congestion prediction image, or may be used for displaying both for another information image, for example, a captured image or the like of a vehicle-mounted camera that captures the outside of the vehicle cabin of the vehicle 10.

The center server 100 (an example of an information notification apparatus) collects the probe information from the vehicles 10, generates the congestion prediction information based on the collected probe information, and distributes the generated congestion prediction information to the vehicle 10 as the target. The center server 100 includes a communication device 110 and a processing device 120.

The functions of the center server 100 may be shared and realized by a plurality of servers. For example, the function of an information distributing unit 1214 to be described below may be realized by another distribution server capable of communicating with the center server 100.

The communication device 110 communicates with the vehicles 10 via the communication network NW under the control of the processing device 120 (specifically, a communication processing unit 1201).

The processing device 120 (an example of a computer) performs various control processing in the center server 100. The functions of the processing device 120 may be realized by any hardware, any software, or the combination of any hardware and any software, and is constituted, for example, by one or a plurality of server computers which includes a CPU, a RAM, a ROM, an auxiliary storage device, an RTC, a communication interface, and the like. For example, the processing device 120 includes the communication processing unit 1201, an analysis data generating unit 1202, a usual congestion situation analyzing unit 1203, a home specifying unit 1204, a parking time analyzing unit 1205, a genre information assigning unit 1206, an event information obtaining unit 1207, a departure timing predicting unit 1208, a departed vehicle number counting unit 1209, a congestion potential deriving unit 1210, a departure peak predicting unit 1211, a predicted congestion level deriving unit 1212, a route information obtaining unit 1213, and the information distributing unit 1214, as functional units realized by the CPU executing one or more programs stored in the ROM or the auxiliary storage device. For example, the processing device 120 includes a storage unit 1200 as a storage region defined in the auxiliary storage device of the server computer, an external storage device connected to the server computer, or the like.

The communication processing unit 1201 controls the communication device 110, and exchanges various signals such as control signals or information signals with the vehicles 10. For example, the communication processing unit 1201 (vehicle information obtaining unit, an example of a movement history information obtaining unit) receives (obtains) the probe information including the vehicle information from the vehicles 10.

The analysis data generating unit 1202 generates analysis data to be used by the usual congestion situation analyzing unit 1203 and the parking time analyzing unit 1205 based on the probe information received from the vehicles 10 by the communication processing unit 1201.

For example, the analysis data generating unit 1202 generates information (probe congestion information) regarding a congestion situation of a road through which the vehicle 10 passes based on information (movement history information) regarding the movement history of the vehicle 10 such as the positional information, the timing information, and the vehicle speed information included in the probe information of each vehicle 10. Specifically, the analysis data generating unit 1202 generates the probe congestion information which includes an identifier (ID) of the vehicle 10, and an ID, a passed date and time, and a congestion level of a road link through which the vehicle 10 passes. Hereinafter, the IDs of the vehicle 10 and the road link are respectively referred to as a vehicle ID and a road link ID. The passed date and time may be at least a date and time when the vehicle enters a certain road link and a date and time when the vehicle leaves the road link. For example, the congestion level is defined based on a time needed for the vehicle to pass through the road link, an average vehicle speed when the vehicle passes through the road link, or the like. Hereinafter, in the embodiment, description will be made on the assumption that the congestion level is defined as a value of 0 to 6 and the larger the value is, the higher the congestion level is.

For example, the analysis data generating unit 1202 generates information (parking situation information) regarding a parking situation of the vehicle 10 based on the positional information, the ACC-OFF information, the ACC-ON information, and the like included in the probe information of each vehicle 10. Specifically, the analysis data generating unit 1202 generates parking situation information which includes the vehicle ID, positional information (positional information of an ACC-OFF location) and timing information (ACC-OFF timing information) when the vehicle 10 enters an ACC-OFF state, and positional information (positional information of an ACC-ON location) and timing information (ACC-ON timing information) when the vehicle 10 subsequently enters an ACC-On state within the most recent time.

The analysis data generating unit 1202 respectively stores the generated probe congestion information and the parking situation information in a probe congestion information DB 1200A and a parking situation information DB 1200B constructed in the storage unit 1200.

The usual congestion situation analyzing unit 1203 (an example of a usual congestion information obtaining unit) analyzes a usual congestion situation of a road link (hereinafter, referred to as a target road link) as a target on a regular basis (for example, every few days) based on the probe congestion information DB 1200A. The road link ID of the target road link is defined in advance in target road link information 1200C of the storage unit 1200. For example, the usual congestion situation analyzing unit 1203 calculates, as a usual congestion level (usual congestion level), an average value of congestion levels for each day of the week and for each time zone of the day for each target road link by using probe congestion information for a predetermined analysis target period (for example, several months back from the day before an analysis date) which are registered in the probe congestion information DB 1200A. The usual congestion levels for each day of the week and for each time zone may be an unweighted average of the congestion levels of the probe congestion information for the same day of the week and the same time zone, or may be a weighted average of which importance becomes higher as the date is updated to the latest date. The time zone may be optionally classified. For example, the time zone may be classified for every predetermined time such as every minute or every hour, or may be classified into morning (for example, from 6 o'clock to 10 o'clock), noon (for example, from 10 o'clock to 16 o'clock), evening (for example, from 16 o'clock to 19 o'clock), night (for example, from 19 o'clock to 23 o'clock), and midnight (for example, from 23 o'clock to 6 o'clock on the next morning). The usual congestion situation analyzing unit 1203 generates, as the usual congestion information, usual congestion level information which includes the road link ID of the target road link, the day of the week, the time zone, and the usual congestion levels corresponding to the road link ID, the day of the week, and the time zone, and stores the generated usual congestion level information in a usual congestion information DB 1200D constructed in the storage unit 1200. The details of the processing performed by the usual congestion situation analyzing unit 1203 will be described below.

The usual congestion situation analyzing unit 1203 may calculate an average congestion level for each weekday (from Monday to Friday) or each holiday (Saturday, Sunday) instead of the average congestion level for each day of the week. For example, the usual congestion information DB 1200D may be constructed based on the congestion information or the like obtained from an external traffic information center or the like.

The home specifying unit 1204 specifies a position of a home of the user (typically, owner) of each vehicle 10 based on the parking situation information DB 1200B. For example, the home specifying unit 1204 specifies, as a home, a location (area) of which the frequency is highest among the positional information of the ACC-OFF locations within a predetermined most recent period for each vehicle 10 by using the parking situation information within the predetermined period (for several months back from the day before a processing date). The home specifying unit 1204 may adopt weighting performed such that the degree of influence on the positional information of the ACC-OFF location having a relatively new date is higher than the degree of influence of the positional influence on the positional information of the ACC-OFF location having a relatively old date in a case where the frequency is calculated. As described above, even when the owner of the vehicle 10 moves into a new home, a position corresponding to the new home is easily specified as the position of the home. The home specifying unit 1204 generates home information which includes the vehicle ID and the positional information of the home of the user of the vehicle ID, and stores the generated home information in a home information DB 1200E constructed in the storage unit 1200. The details of the processing performed by the home specifying unit 1204 will be described below.

For example, the home information DB 1200E may be constructed based on information regarding an address of the home registered by the user of each vehicle 10 in advance through a predetermined website or the like.

The parking time analyzing unit 1205 (an example of a parking time information obtaining unit) analyzes a tendency for a length of a parking time of each vehicle 10 based on the parking situation information DB 1200B. For example, the parking time analyzing unit 1205 calculates an average value (average parking time) of parking times of a point of interest (POI) corresponding to a parking position, that is, a position in which the vehicle enters the ACC-OFF state for each genre defined in advance for each vehicle 10 by using the parking situation information DB 1200B for a predetermined analysis target period (for example, several months back from the day before the analysis date). The genre of the POI is defined in advance in facility attribute information 1200F of the storage unit 1200, and includes, for example, “home” indicating that the POI is the home, “amusement” indicating that the POI is an amusement facility, “eating” indicating that the POI is a facility related to food and drink, “shopping” indicating that the POI is a facility related to shopping, and the like. Hereinafter, in the present embodiment, description will be made on the assumption that the genre of the POI includes “home”, “amusement”, “eating”, and “shopping”. The average parking time for each genre may be a time to an ACC-ON timing from an ACC-OFF timing corresponding to the parking situation information when the vehicle is parked at the POI of the same genre, that is, a unweighted average of the parking times, or may be a weighted average of which importance becomes higher as the date is updated to the latest date. The parking time analyzing unit 1205 generates parking time information which includes the vehicle ID, the genre, and the average parking time, and stores the generated parking time information in a parking time information DB 1200G constructed in the storage unit 1200. The details of the processing performed by the parking time analyzing unit 1205 will be described below.

The genre information assigning unit 1206 performs a process of assigning information (genre information) regarding the genre of the POI corresponding to the parking position to the parking situation information regarding the current parking of the currently parked vehicle 10 among the parking situation information within the parking situation information DB 1200B on a regular basis (for example, every few minutes). Hereinafter, the parking situation information to which the genre information is assigned by the genre information assigning unit 1206 is referred to as parked vehicle information. The details of the process performed by the genre information assigning unit 1206 will be described below.

For example, the event information obtaining unit 1207 obtains information (event information) regarding an event to be held from various application programming interfaces (Web APIs) regarding event information. The event as a target includes exhibitions, fairs, sports events, sports games, concerts, festivals, fireworks shows, and the like. The event information includes information regarding a venue where the event is held, information regarding date and time when the event is held, and the like.

The departure timing predicting unit 1208 predicts a timing (hereinafter, referred to as a departure timing) when the currently parked vehicle 10 is to enter the ACC-ON state, which is determined by the parking situation information DB 1200B on a regular basis (hereinafter, every few minutes). Specifically, the departure timing predicting unit 1208 predicts the departure timing based on the genre of the POI corresponding to the parking position and the average parking time included in the parking time information corresponding to the same genre for each currently parked vehicle 10. Hereinafter, a predicted value of the departure timing may be referred to as an expected departure timing. For example, the expected departure timing may be defined for every few minutes, or may be a predicted value of the time zone when the vehicle 10 substantially enters the ACC-ON state.

The departure timing predicting unit 1208 corrects the expected departure timing of the vehicle 10 based on an end timing of the event when the currently parked vehicle 10 is included in an area of an event being held included in the event information obtained by the event information obtaining unit 1207.

The departure timing predicting unit 1208 updates the parked vehicle information in an aspect in which the expected departure timing is added to the parked vehicle information for each parked vehicle 10, which is generated by the genre information assigning unit 1206. The details of the processing performed by the departure timing predicting unit 1208 will be described below.

The departed vehicle number counting unit 1209 counts the number (the number of most recently departed vehicles) of vehicles 10 which enter the ACC-ON state within the most recent time (for example, most recent few minutes) for each predetermined area (for example, an area indicated by a code value of GeoHash to be described below) on a regular basis. The details of the processing performed by the departed vehicle number counting unit 1209 will be described below.

The congestion potential deriving unit 1210 derives congestion potential for each area (for example, an area indicated by a value of GeoHash to be described below) where the vehicle 10 is parked based on the parked vehicle information for each parked vehicle 10 which is updated by the departure timing predicting unit 1208 on a regular basis (for example, every few minutes). The congestion potential is an index indicating a possibility (risk) of congestion which is likely to occur when the parked vehicle 10 enters the ACC-ON state and enters a surrounding road. For example, the congestion potential may be an increase amount (degree of congestion influence) of the congestion level when the parked vehicle 10 enters the surrounding road. Hereinafter, description will be made on the assumption that the congestion potential is the degree of congestion influence. For example, the congestion potential deriving unit 1210 derives the degree of congestion influence such that the larger the number of vehicles 10 currently parked in a certain area is, the higher the degree of congestion influence is. For example, the congestion potential deriving unit 1210 may derive the degree of congestion influence such that the relatively larger the number of currently parked vehicles is, the higher the degree of congestion influence based on the comparison of the number of vehicles parked in the past within the area with the number of currently parked vehicles. For example, the congestion potential deriving unit 1210 may set the number of vehicles allowed to pass through a cross section corresponding to a road width for each surrounding road of a certain area, and may calculate the degree of influence based on a specific traffic flow simulation or the like. The congestion potential deriving unit 1210 stores the derived congestion potential for each area in a congestion prediction information DB 1200H constructed in the storage unit 1200 in an aspect in which old congestion potential is overwritten and updated. The details of the processing performed by the congestion potential deriving unit 1210 will be described below.

The departure peak predicting unit 1211 (an example of a congestion occurrence timing predicting unit) predicts a peak timing (hereinafter, referred to as a departure peak timing) of the number of parked vehicles 10 that enter the ACC-ON state for each predetermined area, that is, the number of departed vehicles based on the expected departure timings of the currently parked vehicles 10 which are predicted by the departure timing predicting unit 1208 on a regular basis (for example, every few minutes). On the peak of the number of departed vehicles, since a significant amount of vehicles 10 parked in a certain area enter the surrounding road at one time and the congestion on the surrounding road is triggered, the departure peak timing is an example of a timing when the congestion is likely to occur due to the vehicles 10 parked in the area. Similarly to the expected departure timing, the departure peak timing may be defined, for example, every few minutes, or may be substantially a predicted value of a time zone when the number of departed vehicles peaks.

The departure peak predicting unit 1211 determines whether or not the number of departed vehicles counted by the departed vehicle number counting unit 1209 for each area exceeds a predetermined threshold on a regular basis (for example, every few minutes corresponding to a processing cycle of the departed vehicle number counting unit 1209). The predetermined threshold may be a threshold corresponding to a predetermined number of vehicles, or may be a dynamic threshold defined according to the capacity (for example, the number of vehicles allowed to pass through the cross section corresponding to the road width) of the surrounding road. When there is an area in which the number of departed vehicles counted by the departed vehicle number counting unit 1209 exceeds the predetermined threshold, the departure peak predicting unit 1211 modifies the departure peak timing of the area into a current time.

The departure peak predicting unit 1211 stores the departure peak timing for area in the congestion prediction information DB 1200H in an aspect in which an old departure peak timing is overwritten and updated. The details of the processing performed by the departure peak predicting unit 1211 will be described below.

The predicted congestion level deriving unit 1212 (an example of a congestion level predicting unit) derives a congestion level of the congestion which is likely to occur depending on the congestion potential derived by the congestion potential deriving unit 1210. Specifically, the predicted congestion level deriving unit 1212 calculates a predicted value (hereinafter, referred to as a predicted congestion level) of a congestion level of a surrounding road of a predetermined area in which the vehicles 10 are parked based on the usual congestion information DB 1200D and the congestion potential (degree of congestion influence) derived by the congestion potential deriving unit 1210. For example, the predicted congestion level deriving unit 1212 derives the predicted congestion level by adding the usual congestion level of the usual congestion information corresponding to the road link ID of the surrounding road of a certain area and the degree of congestion influence of the area. The predicted congestion level deriving unit 1212 stores the derived predicted congestion level for each area in the congestion prediction information DB 1200H in an aspect in which an old predicted congestion level is overwritten and updated. The details of the processing performed by the predicted congestion level deriving unit 1212 will be described below.

The route information obtaining unit 1213 obtains the route information received from the vehicle 10 by the communication processing unit 1201.

The information distributing unit 1214 (an example of a controller) obtains the congestion prediction information regarding the congestion which is likely to occur in the future on the route corresponding to the route guidance from the congestion prediction information DB 1200H based on the route information obtained by the route information obtaining unit 1213. For example, the information distributing unit 1214 converts the road link ID included in the route information into an area division corresponding to the congestion prediction information by using road link and area conversion information 12001 of the storage unit 1200, and obtains the congestion prediction information corresponding to the converted area from the congestion prediction information DB 1200H. The information distributing unit 1214 transmits distribution data including the obtained congestion prediction information to the vehicle 10 as a distributing target through the communication processing unit 1201. As stated above, the information distributing unit 1214 may display the congestion prediction information on the display 70 of the vehicle 10 as a distribution destination, and may notify the user of the vehicle 10 of the congestion prediction information. The details of the processing performed by the information distributing unit 1214 will be described below.

### Details of Operation of Center Server

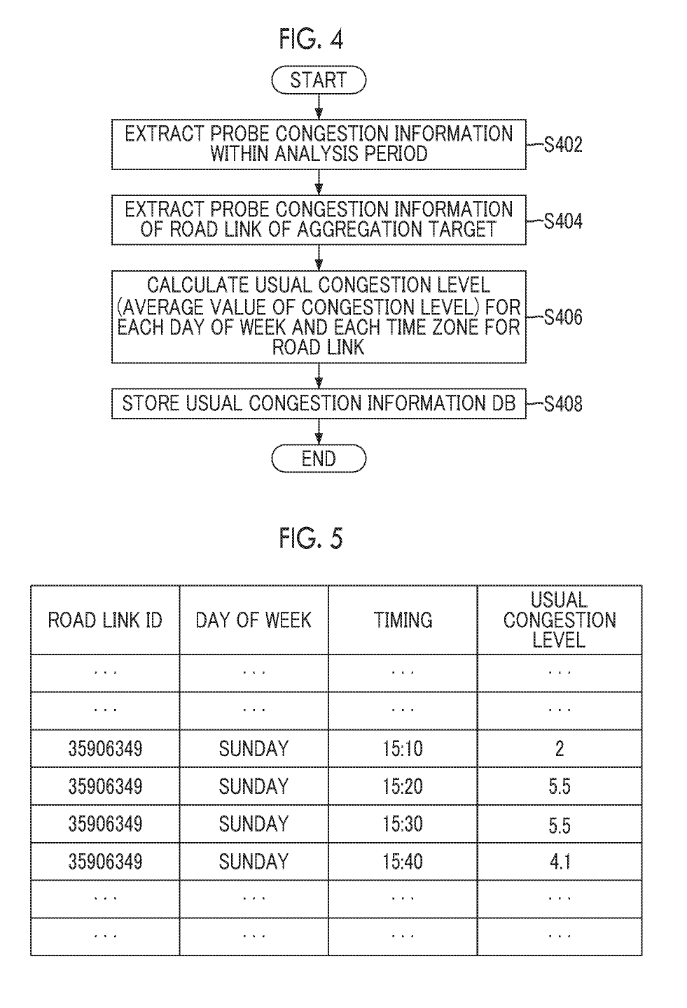

The specific operation of the center server 100 will be described with reference to FIGS. 4 to 20.

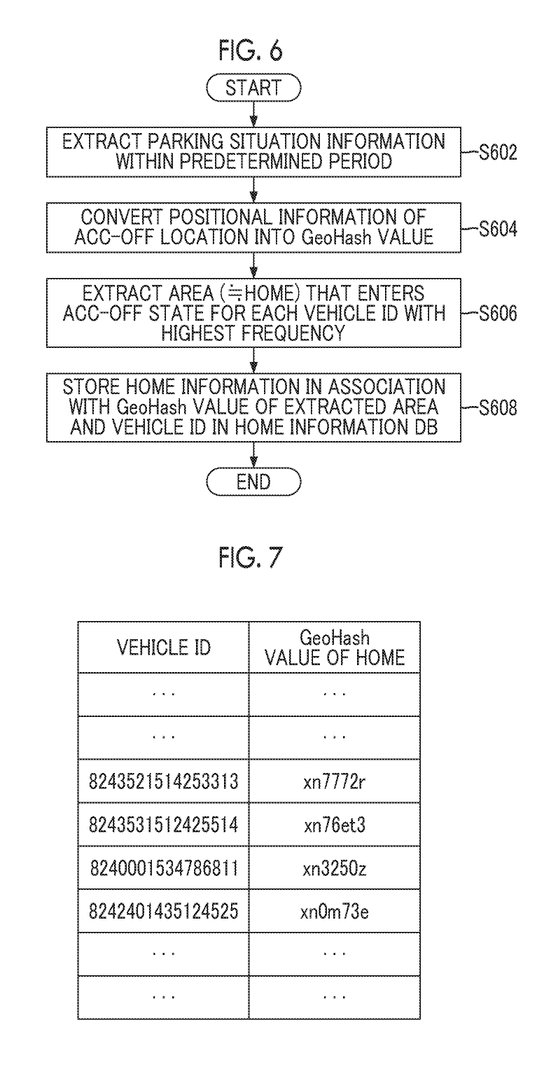

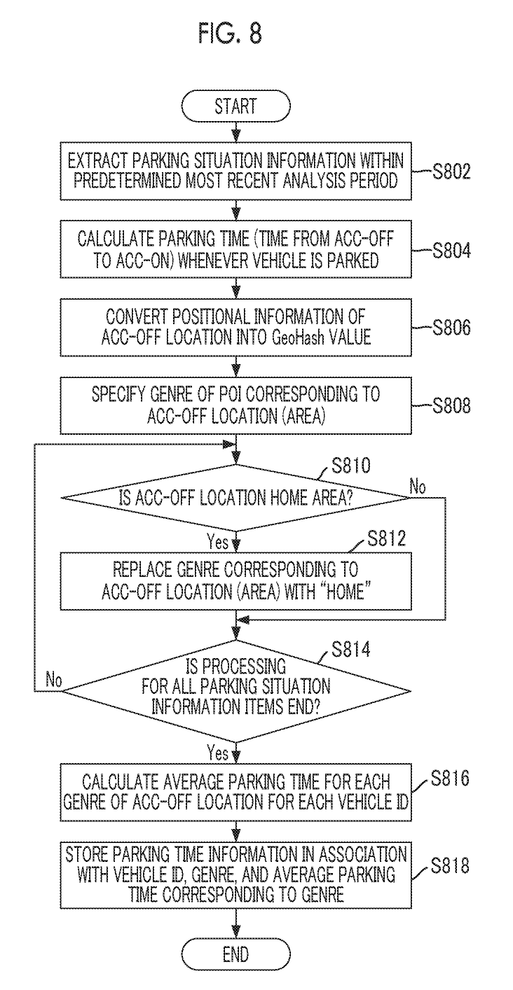

Initially, FIG. 4 is a schematic flowchart showing an example of usual congestion information output processing performed by the usual congestion situation analyzing unit 1203 of the center server 100. The processing shown in the flowchart of FIG. 4 is performed with relatively long intervals on a regular basis (for example, every day to every few days). Hereinafter, the same is true for flowcharts of FIGS. 6 and 8 to be described below.

In step S402, the usual congestion situation analyzing unit 1203 extracts the probe congestion information within an analysis period from the probe congestion information DB 1200A.

In step S404, the usual congestion situation analyzing unit 1203 further extracts the probe congestion information which corresponds to the road link as an aggregation target, that is, includes the road link ID of the road link as an aggregation target from the probe congestion information extracted in step S402 while referring to target road link information 1200C.

In step S406, the usual congestion situation analyzing unit 1203 calculates an average value of the congestion levels for each day of the week and each time zone, that is, the usual congestion levels for each road link as the aggregation target.

In step S408, the usual congestion situation analyzing unit 1203 stores the calculated usual congestion information in the usual congestion information DB 1200D, and ends the current process.

For example, FIG. 5 is a table showing an example of the usual congestion information stored in the usual congestion information DB 1200D.

In the example shown in FIG. 5, the usual congestion information DB 1200D has data in a table format in which the usual congestion information for each day of the week and each time zone are elements of columns. Specifically, the usual congestion level for each time zone for every ten minutes at 15 o'clock on Sunday is represented for the road link indicated by the road link ID of “35906349”.

FIG. 6 is a schematic flowchart showing home specification processing performed by the home specifying unit 1204 of the center server 100.

In step S602, the home specifying unit 1204 extracts the parking situation information within a predetermined most recent period from the parking situation information DB 1200B.

In step S604, the home specifying unit 1204 converts the positional information of the ACC-OFF location into a code value (hereinafter, referred to as a GeoHash value) of GeoHash which is an example of a geocode (geographic coordinates). The GeoHash may express a rectangular area having a predetermined size including a target location represented by latitude and longitude according to the number of digits. For example, a GeoHash value having seven digits may express a rectangular area of about 153 meters×about 153 meters.

A geocode other than the GeoHash, for example, a geocode of an aspect in which an area division is set in advance and a specific ID (area ID) is assigned to each area may be adopted.

In step S606, an area corresponding to the GeoHash value of which the frequency is highest is extracted for each vehicle ID from the positional information of the ACC-OFF location, and the extracted area is specified as the home position.

In step S608, the home specifying unit 1204 generates the home information including the vehicle ID in association with the GeoHash value of the extracted area, stores the generated home information in the home information DB 1200E, and ends the current process.

For example, FIG. 7 is a table showing an example of the home information stored in the home information DB 1200E.

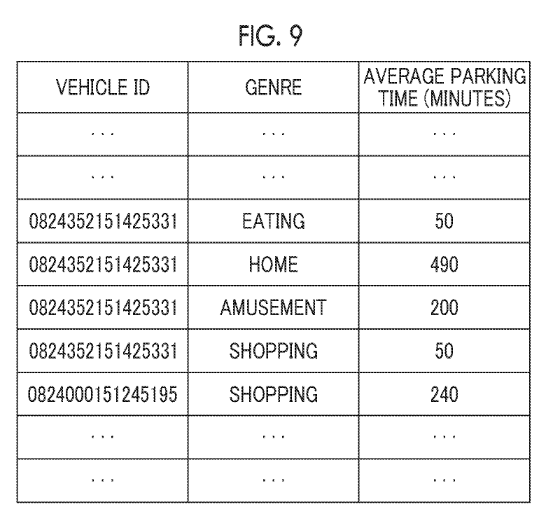

In the example shown in FIG. 7, the home information DB 1200E has data in a table format in which the vehicle IDs of the vehicles 10 and the GeoHash values of the homes of the owners are elements of the columns. Specifically, the vehicle ID is represented by a specific sequence of 16 digits. Hereinafter, the same is true for FIGS. 9, 11, 13, and 15 to be described below. The GeoHash value of the home is a character string of seven digits, and corresponds to the positional information in a range corresponding to the rectangular area of about 153 meters x about 153 meters.

FIG. 8 is a schematic flowchart showing an example of processing for outputting parking time information which is performed by the parking time analyzing unit 1205 of the center server 100.

In step S802, the parking time analyzing unit 1205 extracts the parking situation information within a predetermined most recent analysis period from the parking situation information DB 1200B.

In step S804, the parking time analyzing unit 1205 calculates the parking time (a time from the ACC-OFF timing to the ACC-ON timing) whenever the vehicle 10 is parked based on the extracted parking situation information.

In step S806, the parking time analyzing unit 1205 converts the positional information of the ACC-OFF location of the extracted parking situation information into the GeoHash value.

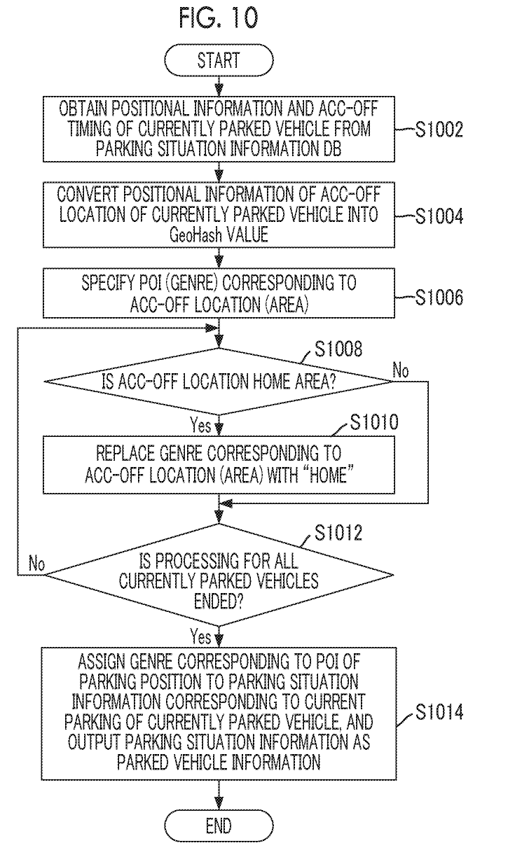

In step S808, the parking time analyzing unit 1205 specifies the POI corresponding to the area indicated by the GeoHash value of the ACC-OFF location, and specifies the genre of the POI. For example, the parking time analyzing unit 1205 may specify the representative POI included in the area based on the POI information DB (not shown) stored in the storage unit 1200. Hereinafter, the same is true for step S1006 of FIG. 10 to be described below.

In step S808, the POI as the target does not include the home. Hereinafter, the same is true for step S1006 of FIG. 10 to be described below.

The processing of step S810, 5812 is performed for each parking situation information extracted in step S802.

In step S810, the parking time analyzing unit 1205 determines whether or not the area indicated by the GeoHash value of the ACC-OFF location corresponding to the parking situation information is the area corresponding to the home position of the user of the vehicle 10 based on the home information DB 1200E. Specifically, the parking time analyzing unit 1205 determines whether or not the GeoHash value of the ACC-OFF location matches the GeoHash value of the home of the user of the vehicle 10 as the target which is stored in the home information DB 1200E. The parking time analyzing unit 1205 proceeds to step S812 when the area indicated by the GeoHash value of the ACC-OFF location is the area corresponding to the home position of the user of the vehicle 10, and proceeds to step S814 in the other case.

In step S812, the parking time analyzing unit 1205 replaces the genre of the POI of the ACC-OFF location corresponding to the parking situation information with “home”.

In step S814, the parking time analyzing unit 1205 determines whether or not the processing for all the extracted parking situation information is ended. The parking time analyzing unit 1205 proceeds to step S816 when the processing for all the extracted parking situation information is ended. When the processing for all the extracted parking situation information is not ended, the parking time analyzing unit returns to step S810, changes the parking situation information as the processing target, and repeats the processing of step S810, 5812.

In step S816, parking time analyzing unit 1205 calculates an average parking time for each genre of the POI corresponding to the parking position (ACC-OFF location) for each vehicle ID.

In step S818, the parking time analyzing unit 1205 stores the parking time information in association with the vehicle ID, the genre corresponding to the POI of the ACC-OFF location, and the average parking time corresponding to the genre in the parking time information DB 1200G and ends the current processing.

For example, FIG. 9 is a table showing an example of the parking time information stored in the parking time information DB 1200G

In the example shown in FIG. 9, the parking time information DB 1200G has data in a table format in which the vehicle ID, the genre of the POI corresponding to the parking position (ACC-OFF location), and the average parking times corresponding to the genre are elements of columns. Specifically, as stated above, “50 minutes”, “490 minutes”, “200 minutes”, and “50 minutes” are respectively stored for the genres of “eating”, “home”, “amusement”, and “shopping”, as the average parking times of the vehicle 10 having the vehicle ID of “0824352151425331”. “240 minutes” is stored for the genre of “shopping”, as the average parking time of the vehicle 10 having the vehicle ID of “0824000151245195”.

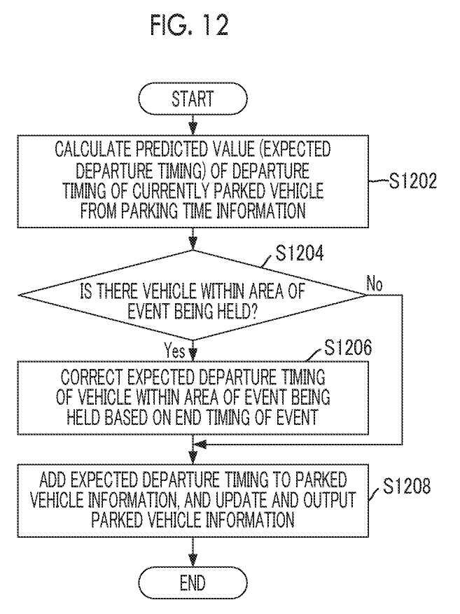

FIG. 10 is a schematic flowchart showing an example of processing for outputting parked vehicle information which is performed by the genre information assigning unit 1206 of the center server 100. The processing shown in the flowchart of FIG. 10 is repeatedly performed with relatively short intervals on a regular basis (for example, every few minutes). Hereinafter, the same is true for FIGS. 12, 14, and 16.

In step S1002, the genre information assigning unit 1206 obtains the ACC-OFF timing information and the positional information of the ACC-OFF location of the currently parked vehicle 10 from the parking situation information DB 1200B. For example, the currently parked vehicle 10 may be the vehicle 10 that enters the ACC-OFF state but does not subsequently enter the ACC-ON state at a point of time before few minutes. That is, the currently parked vehicle 10 may include the departed vehicle that enters the ACC-ON state within the most recent few minutes.

In step S1004, the genre information assigning unit 1206 converts the extracted positional information of the ACC-OFF location into the GeoHash value.

In step S1006, the genre information assigning unit 1206 specifies the POI corresponding to the area indicated by the GeoHash value of the parking position (ACC-OFF location) of the vehicle 10 being currently parked, and specifies the genre of the POI.

The processing of steps S1008, S1010 is performed for each currently parked vehicle 10.

In step S1008, the genre information assigning unit 1206 determines whether or not the area indicated by the GeoHash value of the parking position (ACC-OFF location) of the currently parked vehicle 10 is the area corresponding to the home position of the user of the vehicle 10 based on the home information DB 1200E. Specifically, the genre information assigning unit determines whether or not the GeoHash value of the ACC-OFF location of the vehicle 10 as the target matches the GeoHash value of the home of the user of the vehicle 10 which is stored in the home information DB 1200E. The genre information assigning unit 1206 proceeds to step S1010 when the area indicated by the GeoHash value of the parking position (ACC-OFF location) of the currently parked vehicle 10 is the area corresponding to the home position of the user of the vehicle 10, and proceeds to step S1012 in the other case.

In step S1010, the genre information assigning unit 1206 replaces the POI corresponding to the area indicated by the GeoHash value of the parking position (ACC-OFF location) of the vehicle 10 being currently parked with “home”.

In step S1012, the genre information assigning unit 1206 determines whether or not the processing for all the currently parked vehicles 10 is ended. The genre information assigning unit 1206 proceeds to step S1014 when the processing for all the currently parked vehicles 10 is ended. When the processing is not ended, the genre information assigning unit returns to step S1008, changes the vehicle 10 as the processing target, and repeats the processing of steps S1008, S1010.

In step S1014, the genre information assigning unit 1206 assigns the genre corresponding to the POI of the parking position (ACC-OFF location) to the parking situation information corresponding to the current parking situation of the vehicle 10 being currently parked, outputs the parking situation information as the parked vehicle information, and ends the current processing.

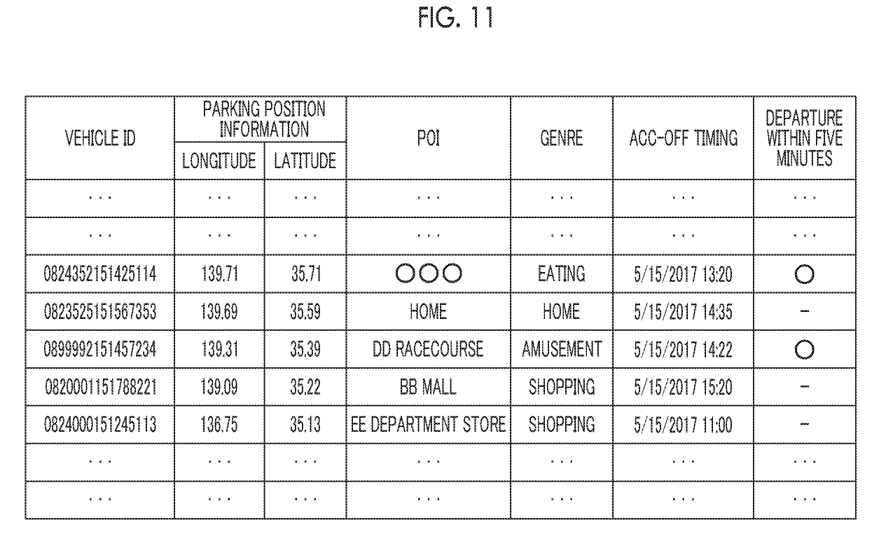

For example, FIG. 11 is a table showing an example of the parked vehicle information output by the genre information assigning unit 1206.

In the example shown in FIG. 11, the parked vehicle information is output as data in a table format in which the vehicle ID of the vehicle 10 that does not enter the ACC-ON state five minutes ago, the latitude and longitude of the parking position, the POI corresponding to the parking position, the genre of the POI, the ACC-OFF timing, information (information indicating whether or not there is the most recently departed vehicle) regarding the presence or absence of the departed vehicle (that enters the ACC-ON state) within the most recent five minutes are elements of columns.

FIG. 12 is a schematic flowchart showing an example of processing for updating and outputting parked vehicle information which is performed by the departure timing predicting unit 1208 of the center server 100.

In step S1202, the departure timing predicting unit 1208 calculates a predicted value (expected departure timing) of a timing (departure timing) when the currently parked vehicle 10 enters the ACC-ON state based on the parking time information DB 1200G Specifically, the average parking time during which the vehicle is parked in the genre of the POI corresponding to the parking position is added to the ACC-ON timing of the currently parked vehicle 10, and thus, the expected departure timing is calculated.

In step S1204, the departure timing predicting unit 1208 determines whether or not there is the vehicle 10 present within the area of the event being held included in the event information obtained by the event information obtaining unit among the currently parked vehicles 10. The departure timing predicting unit 1208 proceeds to step S1206 when there is the vehicle 10 present within the area of the event being held, and proceeds to step S1208 when there is no vehicle 10 present within the area of the event being held.

In step S1206, the departure timing predicting unit 1208 corrects the expected departure timing of the vehicle 10 present within the area of the event being held based on the end timing of the event. The departure timing predicting unit 1208 may correct the expected departure timing in the end timing of the event, or may correct the expected departure timing in an aspect in which a predetermined time is added to the end timing of the event with consideration for a time during which the user moves to the vehicle 10 from an event site.

In step S1208, the departure timing predicting unit 1208 updates and outputs the parked vehicle information by adding the expected departure timing to the parked vehicle information output from the genre information assigning unit 1206, and ends the current processing.

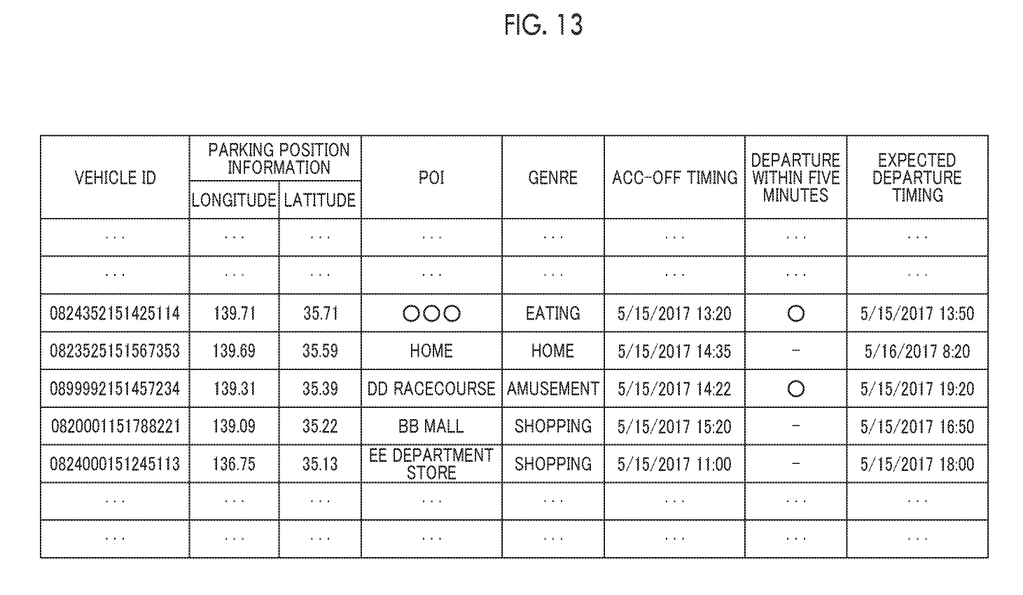

For example, FIG. 13 is a table showing an example of the parked vehicle information updated and output from the departure timing predicting unit 1208, and specifically shows the parked vehicle information updated and output on the assumption of the parked vehicle information of FIG. 11.

In the example shown in FIG. 13, the parked vehicle information is output as data in a table format in which the added expected departure timings are elements of columns in addition to the vehicle ID of the vehicle 10 that does not enter the ACC-ON state five minutes ago, the latitude and longitude of the parking position, the POI corresponding to the parking position, the genre of the POI, the ACC-OFF timing, and the information (information indicating whether or not there is the most recently departed vehicle) regarding the presence or absence of the departed vehicle (that enters the ACC-ON state) within the most recent five minutes.

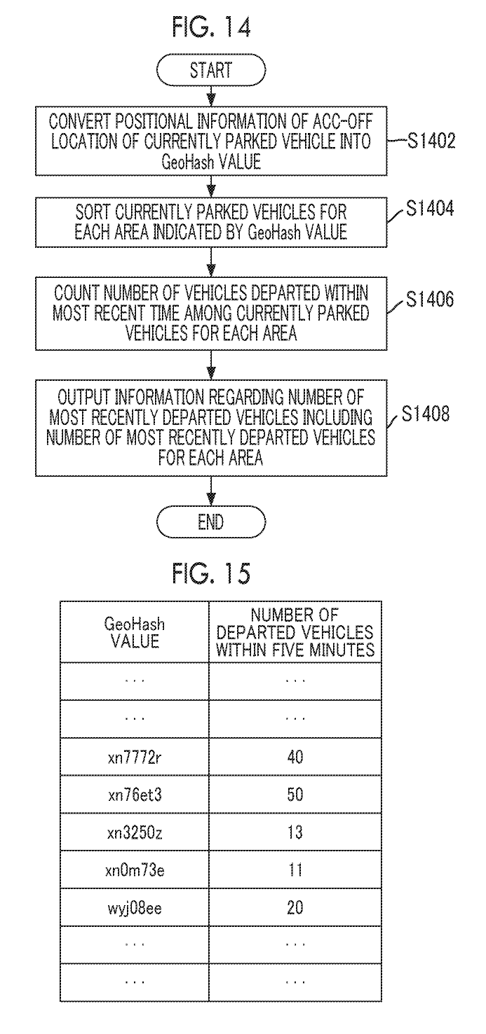

FIG. 14 is a schematic flowchart showing an example of processing for outputting information regarding the number of most recently departed vehicles which is performed by the departed vehicle number counting unit 1209 of the center server 100.

In step S1402, the departed vehicle number counting unit 1209 converts the positional information of the ACC-OFF location of the currently parked vehicle 10 into the GeoHash value.

In step S1404, the departed vehicle number counting unit 1209 sorts the currently parked vehicles 10 for each area indicated by the GeoHash value.

In step S1406, the departed vehicle number counting unit 1209 counts the number (the number of most recently departed vehicles) of vehicles 10 that enter the

ACC-ON state within the most recent time (specifically, most recent few minutes) for each area corresponding to the GeoHash value which is included in the currently parked vehicle 10. For example, the information indicating whether or not there is the most recently departed vehicle is included in the parked vehicle information of FIG. 13. Thus, the departed vehicle number counting unit 1209 may count the number of vehicles 10 departed within most recent few minutes by using the information indicating whether or not there is the most recently departed vehicle included in the parked vehicle information.

In step S1408, the departed vehicle number counting unit 1209 outputs the information regarding the number of most recently departed vehicles including the number of most recently departed vehicles for each area, and ends the current processing.

For example, FIG. 15 is a table showing an example of the information regarding the number of most recently departed vehicles.

In the example shown in FIG. 15, the information regarding the number of most recently departed vehicles is output as data in a table format in which the GeoHash values of the areas including the parked vehicles 10 and the number of most recently departed vehicles (specifically, the number of vehicles departed within most recent five minutes) of the area are elements of columns.

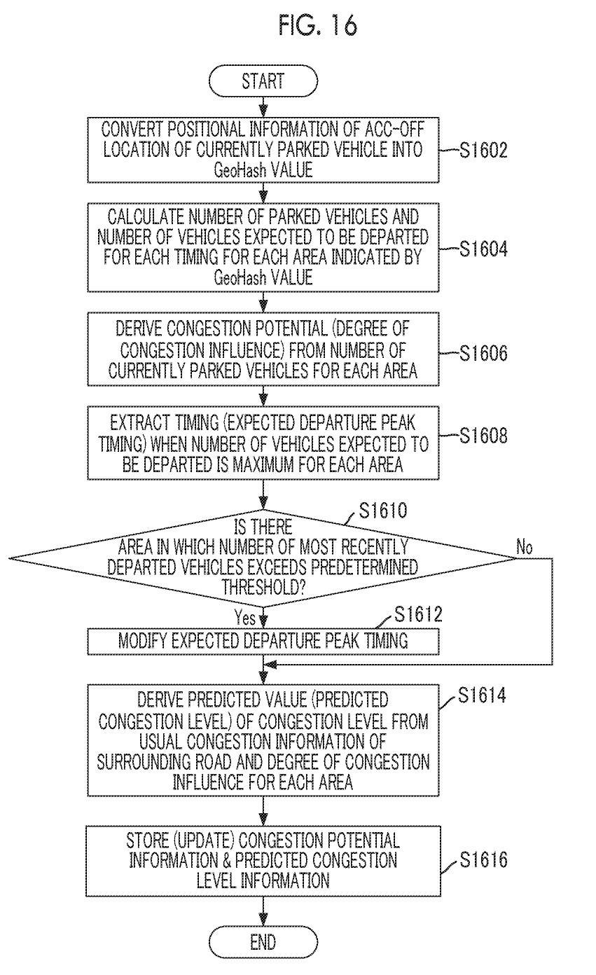

FIG. 16 is a schematic flowchart showing an example of processing for outputting congestion prediction information which is performed by the center server 100.

In step S1602, the congestion potential deriving unit 1210 converts the positional information of the ACC-OFF location of the currently parked vehicle 10 into the GeoHash value.

In step S1604, the congestion potential deriving unit 1210 calculates the number of newly parked vehicles 10 and the number (the number of most recently departed vehicles) of newly departed vehicles 10 and the number of vehicles expected to be parked and the number of vehicles expected to be departed for timing such as few minutes to several tens of minutes from now on, that is, each passing time such as few minutes to several tens of minutes for each area indicated by the GeoHash value of the currently parked vehicle based on the parked vehicle information updated and output by the departure timing predicting unit 1208.

In step S1606, the congestion potential deriving unit 1210 derives the congestion potential (the degree of congestion influence) based on the number of newly parked vehicles (the number of currently parked vehicles) of the vehicles 10 for each area indicated by the GeoHash value of the currently parked vehicle 10.

In step S1608, the departure peak predicting unit 1211 derives an expected departure peak timing for each area indicated by the GeoHash value of the currently parked vehicle 10.

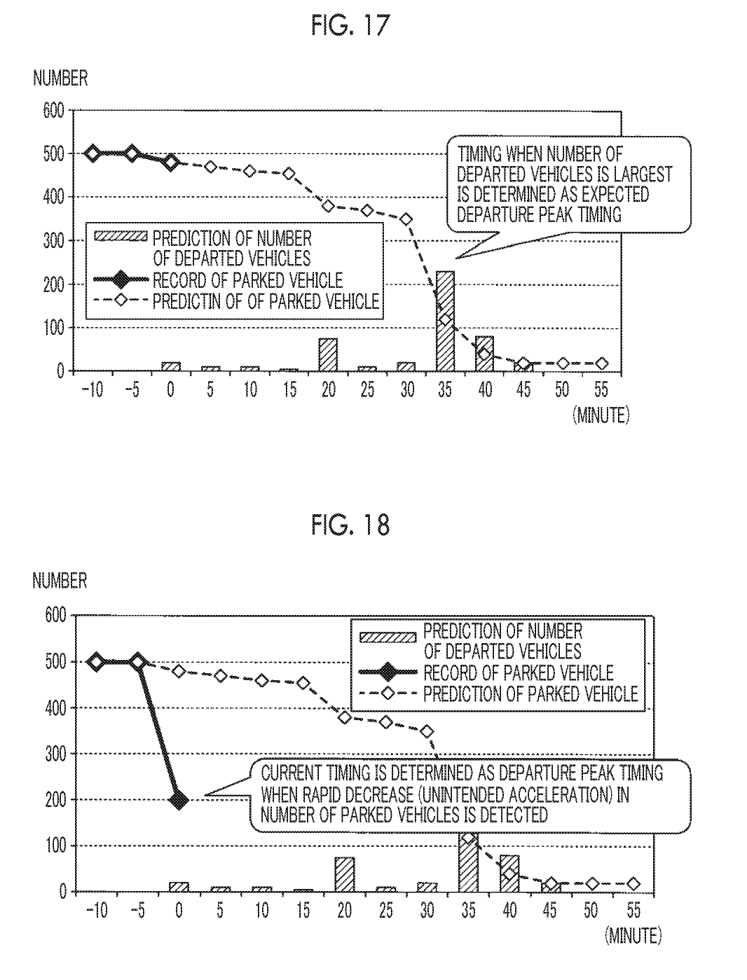

For example, FIG. 17 is a graph for describing a method of deriving the expected departure peak timing. Specifically, FIG. 17 is a graph showing the record of the number of vehicles parked in a certain area, a predicted value (the number of vehicles expected to be parked) of the number of vehicles parked from now on, and the number of vehicles expected to be departed from now on in a time-series manner.

As shown in FIG. 17, the departure peak predicting unit 1211 may extract a timing when the number of vehicles expected to be parked very greatly decreases, that is, a timing when the number of vehicles expected to be departed is maximum, as the expected departure peak timing.

Referring back to FIG. 16, in step S1610, the departure peak predicting unit 1211 determines whether or not there is the area in which the number of most recently departed vehicles exceeds a predetermined threshold among the areas indicated by the GeoHash values of the currently parked vehicles 10. The departure peak predicting unit 1211 proceeds step S1612 when there is the area in which the number of most recently departed vehicles exceeds the predetermined threshold, and proceeds to step S1614 when there is no area in which the number of most recently departed vehicles exceeds the predetermined threshold.

In step S1612, the departure peak predicting unit 1211 modifies the expected departure peak timing of the area in which the number of most recently departed vehicles exceeds the predetermined threshold.

For example, FIG. 18 is a graph for describing a method of modifying the expected departure peak timing. Specifically, similarly to FIG. 17, FIG. 18 is a graph showing the record of the number of vehicles parked in a certain area, the predicted value (the number of vehicles expected to be parked) of the number of vehicles to be parked from now on, and the number of vehicles expected to be departed from now on in a time-series manner.

As shown in FIG. 18, when the number of most recently departed vehicles exceeds the predetermined threshold and the number of parked vehicles 10 rapidly decreases greatly in a certain area, the departure peak predicting unit 1211 may determine that the current time is the departure peak timing, and may modify the expected departure peak timing.

Referring back to FIG. 16, in step S1614, the predicted congestion level deriving unit 1212 derives a predicted value (predicted congestion level) of the congestion level of the surrounding road based on the usual congestion information of the surrounding road including the road link within the area and the congestion potential (degree of congestion influence) derived by the congestion potential deriving unit 1210, for each area indicated by the GeoHash value of the currently parked vehicle 10. For example, the predicted congestion level deriving unit 1212 extracts the road link within the area and road links included in adjacent areas indicated by eight adjacent GeoHash values adjacent to the area. The predicted congestion level deriving unit 1212 derives the predicted congestion level by adding the degree of congestion influence to the usual congestion level of the time zone (timing) corresponding to the expected departure peak timing, which is included in the usual congestion level information corresponding to the road link IDs of the extracted road links.

In step S1616, the congestion potential deriving unit 1210, the departure peak predicting unit 1211, and the predicted congestion level deriving unit 1212 update and store the output congestion potential, expected departure peak timing, and predicted congestion level in the congestion prediction information DB 1200H.

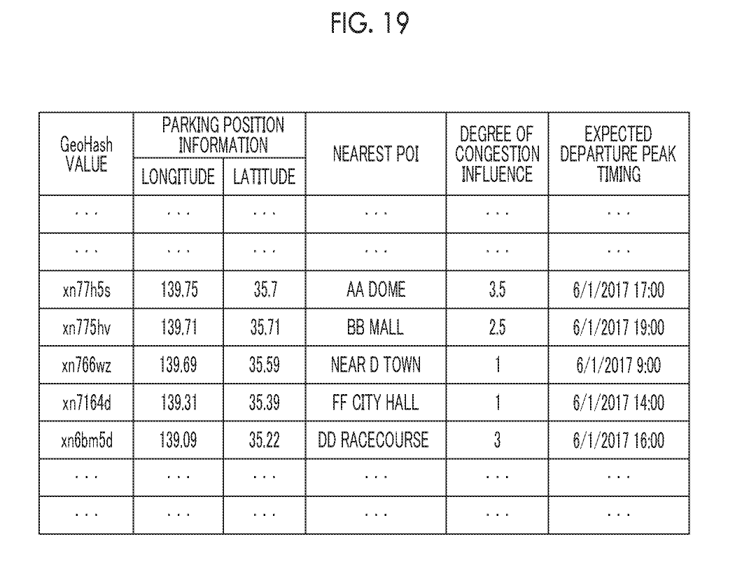

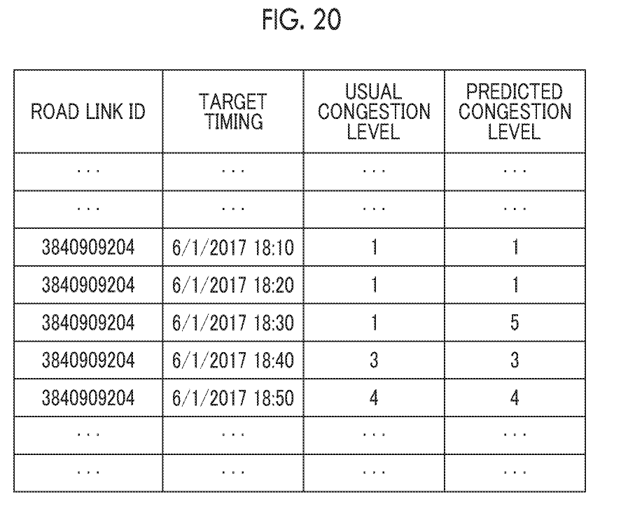

For example, FIG. 19 is a schematic table showing an example of the congestion potential information including the congestion potential (the degree of congestion influence) and the expected departure peak timing which are stored in the congestion prediction information DB 1200H. FIG. 20 is a table showing an example of the predicted congestion level information including the predicted congestion level, which is stored in the congestion prediction information DB 1200H.

In the example shown in FIG. 19, the congestion potential information is stored as data in a table format in which the GeoHash value of the area including the parked vehicle 10, the longitude and latitude of the parking position corresponding to the GeoHash value, the nearest POI corresponding to the area, the degree of congestion influence, and the expected departure peak timing are elements of columns in the congestion prediction information DB 1200H.

In the example shown in FIG. 20, the predicted congestion level information is stored as data in a table format in which the road link ID, a target timing represented for every 10 minutes, a usual congestion level corresponding to the target timing based on the usual congestion information DB 1200D, and the predicted congestion level are elements of columns in the congestion prediction information DB 1200H.

In the present example, the expected departure peak timing of the vehicle 10 currently parked in the area corresponding to the road link having the road link ID of “3840909204” is “Jun. 1, 2017 18:30”. Thus, the predicted congestion level of the road link having the road link ID of “3840909204” in “Jun. 1, 2017 18:30” is set as “5” obtained by adding the degree of congestion influence of “4” to the usual congestion level of “1” in the time zone of “18:30” on the same day of the week as “Jun. 1, 2017”.

In the present example, the usual congestion levels and the predicted congestion levels of the road link having the road link ID of “3840909204” in time zones (“Jun. 1, 2017 18:10”, “18:20”, “18:40”, and “18:50”) before and after the expected departure peak timing are also stored. Here, since the degree of congestion influence caused by the currently parked vehicle 10 is not added to the predicted congestion levels of the road link having the road link ID of “3840909204” in the time zones before and after the expected departure peak timing of the vehicle 10 currently parked in the area corresponding to the road link ID before and after the expected departure peak timing, the same value as the usual congestion level in the same time zone is set.

The degree of congestion influence may be calculated for the time zones before and after the expected departure peak timing by using the number of vehicles expected to be parked, the number of vehicles expected to be departed for each timing such as every few minutes to tens of minutes from now on, and the like, which are calculated in step S1604, and may calculate the predicted congestion level to which the degree of congestion influence is added. For example, the congestion level may be higher than the usual congestion depending on the number of departed vehicles 10 in the expected departure peak timing even in the time zone after the expected departure peak timing. Thus, the congestion potential deriving unit 1210 may derive the degree of congestion influence in the time zone after the expected departure peak timing depending on the magnitude of the number of vehicles expected to be departed in the expected departure peak timing, and the predicted congestion level deriving unit 1212 may derive the predicted congestion level in the time zone based on the degree of congestion influence. For example, when the number of vehicles expected to be departed is relatively large even in a time zone other than the expected departure peak timing, there is a possibility that the congestion level will be higher than the usual congestion. Thus, the congestion potential deriving unit 1210 may derive the degree of congestion influence such that the larger the number of vehicles expected to be departed is, the higher the predicted congestion level is depending on the number of vehicles expected to be departed in a time zone other than the expected departure peak timing, and the predicted congestion level deriving unit 1212 may derive the predicted congestion level in the time zone based on the degree of congestion influence.

Hereinafter, description will be made on the assumption that the congestion potential information including the congestion potential and the expected departure peak timing and the predicted congestion level information including the predicted congestion level are stored in the congestion prediction information DB 1200H.

### Details of Entire Operation of Information Notification System 1

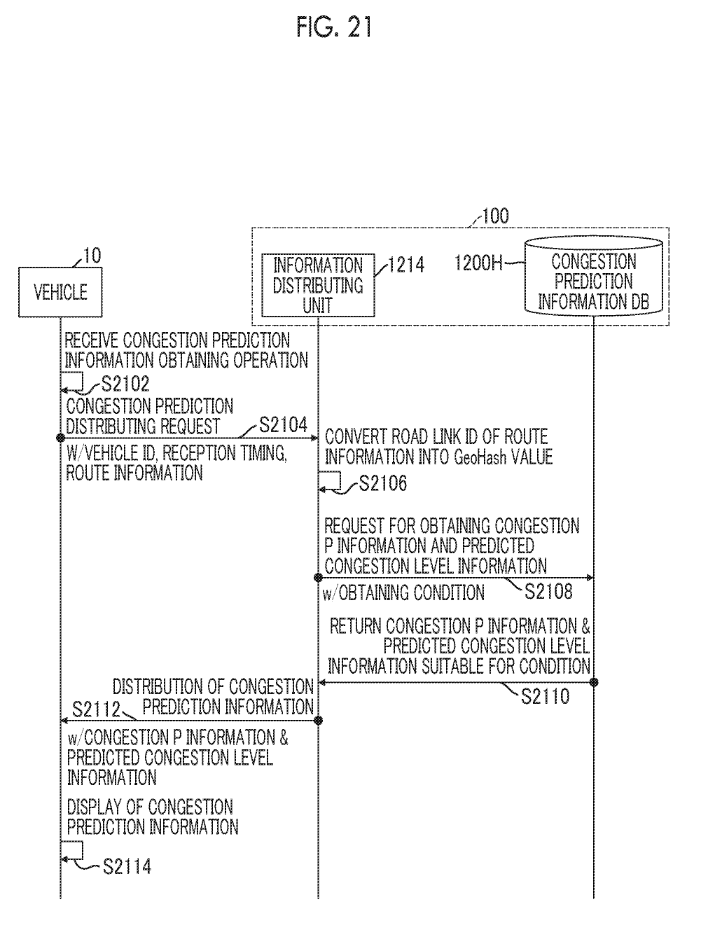

The specific entire operation of the information notification system 1 will be described with reference to FIGS. 21 to 24.

FIG. 21 is a schematic sequence diagram showing an example of the entire operation of the information notification system 1 according to the present embodiment.

In step S2102, the congestion prediction information providing unit 204 of the vehicle 10 receives an operation (congestion prediction information obtaining operation) for obtaining the congestion prediction information from the user of the vehicle 10, for example, a touch operation of the user for a predetermined button displayed on a touch panel type display 70.

In step S2102, when the congestion prediction information providing unit 204 of the vehicle 10 receives the congestion prediction information obtaining operation from the user, the congestion prediction information providing unit 204 of the vehicle 10 transmits a congestion prediction information distributing request to the center server 100 through the DCM 30 in step S2104. At this time, the congestion prediction information distributing request transmitted to the center server 100 includes the vehicle ID, a reception timing of the congestion prediction information obtaining operation based on the RTC 25, the route information, and the like.

When the route is not set by the navigation unit 203 and the congestion prediction information obtaining operation is received, the congestion prediction information providing unit 204 may display a notification screen for requesting that the user sets the route (that is, sets the destination) on the display 70 through the display processing unit 202. When the route is not set by the navigation unit 203 and the congestion prediction information obtaining operation is received, the congestion prediction information providing unit 204 may set the destination based on the movement history of the vehicle 10 or the like, and may request that the navigation unit 203 searches for the route. When the route is set by the navigation unit 203 in response to a predetermined operation of the user, the congestion prediction information providing unit 204 may transmit the congestion prediction information distributing request to the center server 100 through the DCM 30.

In step S2106, when the congestion prediction information distributing request is received by the communication processing unit 1201 and the route information included in the congestion prediction information distributing request is obtained by the route information obtaining unit 1213, the information distributing unit 1214 of the center server 100 changes the road link ID included in the route information to the GeoHash value. The GeoHash value corresponding to the road link ID is stored in the road link and area conversion information 12001. For example, any road link ID in association with the GeoHash values corresponding to the latitudes and longitudes of a starting end and a termination end and eight adjacent GeoHash values thereof is stored in the road link and area conversion information 12001. The information distributing unit 1214 may convert a plurality of road link IDs included in the route information into the corresponding GeoHash values by using the road link and area conversion information 12001.

In step S2108, the information distributing unit 1214 of the center server 100 outputs a request for obtaining the congestion potential information including the degree of congestion influence and the expected departure peak timing and the predicted congestion level information including the predicted congestion level to the congestion prediction information DB 1200H. At this time, the obtaining request includes conditions for obtaining the congestion potential information and the predicted congestion level information. The condition for obtaining the congestion potential information includes the GeoHash value output in step S2106. The condition for obtaining the predicted congestion level information includes the road link ID included in the route information and the expected passing timing corresponding to each road link ID.

In step S2110, the information distributing unit 1214 of the center server 100 obtains the congestion potential information and the predicted congestion level information returned from the congestion prediction information DB 1200H, as information suitable for the obtaining condition from the congestion prediction information DB 1200H. That is, the information distributing unit 1214 obtains the congestion potential information corresponding to the GeoHash value included in the obtaining condition and the predicted congestion level information corresponding to the road link ID included in the obtaining condition from the congestion prediction information DB 1200H.

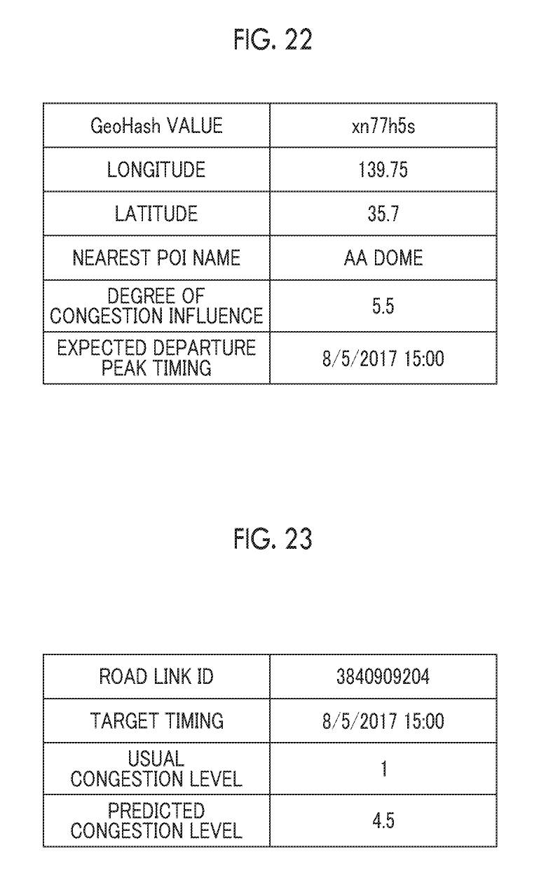

For example, FIGS. 22 and 23 are tables showing examples of the congestion potential information and the predicted congestion level information returned to the information distributing unit 1214 from the congestion prediction information DB 1200H, respectively.

In the example shown in FIG. 22, the information distributing unit 1214 outputs the obtaining request using the GeoHash value of “xn77h5s” as one of the obtaining conditions to the congestion prediction information DB 1200H. The congestion potential information which includes the longitude (“139.75”), the latitude (“35.7”), the nearest POI name (“AA dome”), the degree of congestion influence (“5.5”), and the expected departure peak timing (“Aug. 5, 2017 15:00”) which correspond to the GeoHash value of “xn77h5s” is returned to the information distributing unit 1214 from the congestion prediction information DB 1200H.

In the example shown in FIG. 23, the information distributing unit 1214 outputs the obtaining request using the road link ID of “3840909204” and the target timing of “Aug. 5, 2017 15:00” as one of the obtaining conditions to the congestion prediction information DB 1200H. The predicted congestion level information which includes the usual congestion level and the predicted congestion level corresponding to the road link ID of “3840909204” and the target timing of “Aug. 5, 2017 15:00” is returned to the information distributing unit 1214 from the congestion prediction information DB 1200H.

Referring back to FIG. 21, in step S2112, the information distributing unit 1214 of the center server 100 distributes the congestion prediction information which includes the obtained congestion potential information and the predicted congestion level information to the vehicle 10 as a transmission source of the congestion prediction information distributing request through the communication processing unit 1201.

In step S2114, the congestion prediction information providing unit 204 of the vehicle 10 displays the congestion potential information 200B and the predicted congestion level information 200C which are received from the center server 100 by the DCM 30 and are stored in the storage unit 200 on the display 70 through the display processing unit 202. The specific display aspect will be described below.

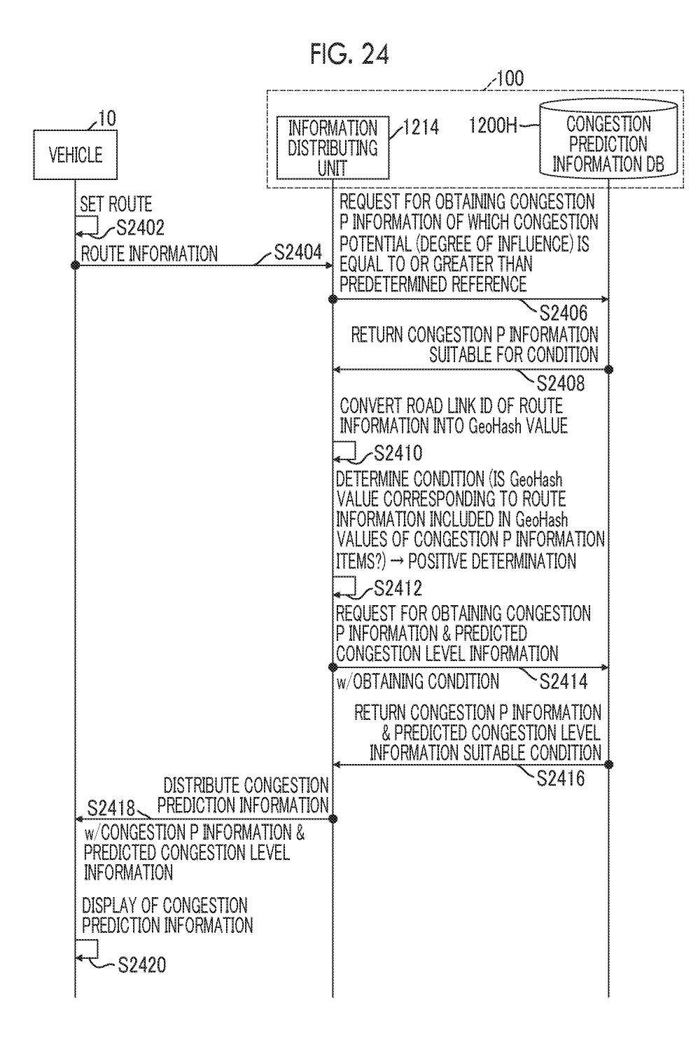

FIG. 24 is a schematic sequence diagram showing another example of the entire operation of the information notification system 1 according to the present embodiment. In the present example, the information distributing unit 1214 distributes the congestion prediction information to the vehicle 10 in a push manner, unlike the example shown in FIG. 21.

In step S2402, the navigation unit 203 of the vehicle 10 sets the route from the current location to the destination according to the setting operation of the destination by the user or the destination set based on the movement history of the vehicle 10 or the like.

In step S2404, when the route is set by the navigation unit 203, the congestion prediction information providing unit 204 of the vehicle 10 transmits the route information regarding the set route to the center server 100 through the DCM 30. At this time, the route information transmitted to the center server 100 includes the road link ID of the road link through which the vehicle passes from the current location to the destination, the expected passing timing when the vehicle passes through the road link, and the like, as stated above.

In step S2406, when the route information is received by the communication processing unit 1201 and the route information is obtained by the route information obtaining unit 1213, the information distributing unit 1214 of the center server 100 outputs the request for obtaining the congestion potential information using the fact that the congestion potential, that is, the degree of congestion influence is equal to or greater than a predetermined reference (for example, is equal to or greater than “4”) as the obtaining condition to the congestion prediction information DB 1200H.

In step S2408, the information distributing unit 1214 of the center server 100 obtains the congestion potential information returned from the congestion prediction information DB 1200H, as the information suitable for the obtaining condition from the congestion prediction information DB 1200H. That is, the information distributing unit 1214 obtains the congestion potential information of which the degree of congestion influence is equal to or greater than the predetermined reference from the congestion prediction information DB 1200H.

In step S2410, the information distributing unit 1214 of the center server 100 changes the road link ID included in the route information into the GeoHash value by using the road link and area conversion information 12001.

In step S2412, the information distributing unit 1214 of the center server 100 determines whether or not the GeoHash value (that is, the GeoHash value output in step S2410) corresponding to the route information is included in the GeoHash values of the obtained congestion potential information.

In step S2414, when the GeoHash value (the GeoHash value output in step S2410) corresponding to the route information is included in the GeoHash values of the obtained congestion potential information (that is, when the determination result is positive), the information distributing unit 1214 of the center server 100 outputs the request for obtaining the congestion potential information and the predicted congestion level information to the congestion prediction information DB 1200H, similarly to step S2108.

When the GeoHash value corresponding to the route information is not included (that is, when the determination result is negative), the information distributing unit 1214 of the center server 100 ends the current processing using the transmission of the route information to the center server 100 from the vehicle 10 as a trigger.

Hereinafter, the processing of steps S2414 to S2420 is the same as the processing of steps S2108 to S2114 of FIG. 21, and thus, the description thereof will be omitted.

In the present example, when the area in which the degree of congestion influence is equal to or greater than the predetermined reference is included in the areas indicated by the GeoHash values corresponding to the route (road link) set by the navigation unit 203 of the vehicle 10, the congestion prediction information is distributed from the center server 100 to the vehicle 10 in the push manner. As stated above, when the set route or an area surrounding the route has relatively high congestion potential indicating that the congestion may occur, the user can ascertain the congestion prediction information displayed on the display 70 irrespective of whether or not the user performs the operation. Thus, user convenience is improved.

### Specific Display Aspect of Congestion Prediction Information

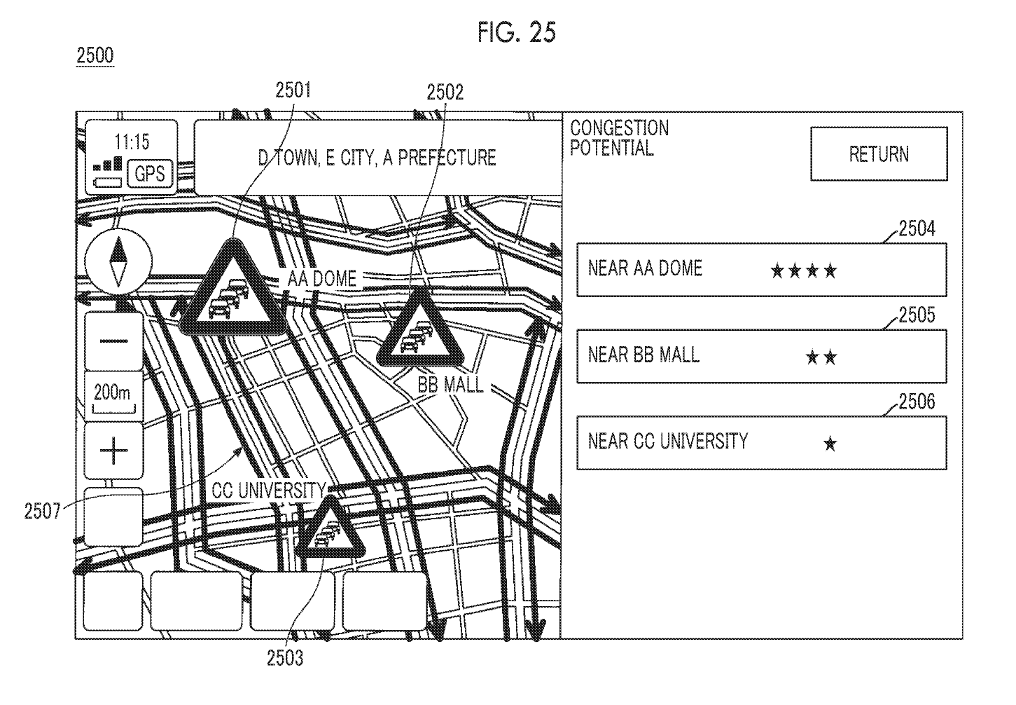

A specific display aspect of the congestion prediction information on the display 70 will be described with reference to FIG. 25.

FIG. 25 is a diagram showing an example (screen 2500) of the navigation image displayed on the display 70.

As shown in FIG. 25, the map image is displayed on the screen 2500 displayed on the display 70. For example, the map image of the screen 2500 may be the map image of the area selected by the selection operation of the user among the areas along the route set by the navigation unit 203. For example, the map image of the screen 2500 may be the map image of the area automatically selected by the congestion prediction information providing unit 204 among the areas along the route set by the navigation unit 203. In this case, the congestion prediction information providing unit 204 may select the area corresponding to the highest degree of congestion influence among the degrees of congestion influence included in the congestion potential information 200B.

Image objects 2501 to 2503 corresponding to the congestion potential (degrees of congestion influence) are displayed so as to be superimposed on the map image of the screen 2500.

The image objects 2501 to 2503 represent the congestion potential (the degrees of congestion influence) of the areas indicated by the GeoHash values corresponding to the positions indicated by the latitudes and longitudes on the map image. Specifically, the image objects 2501 to 2503 have different sizes, and the sizes thereof correspond to the magnitudes of the degrees of congestion influence.

For example, the image object 2501 is displayed in the area near “AA dome” on the map image so as to be superimposed, and has the largest size among the image objects 2501 to 2503. That is, the image object 2501 represents that the congestion potential of the congestion which is likely to occur due to the currently parked vehicles 10 in the area near “AA dome” is the highest in the range corresponding to the map image included in the screen 2500.

The image object 2502 is displayed in the area near “BB mall” on the map image so as to be superimposed, and has the second largest size among the image objects 2501 to 2503. That is, the image object 2502 represents that the congestion potential of the congestion which is likely to occur due to the currently parked vehicles 10 in the area near “BB mall” is the second highest in the range corresponding to the map image included in the screen 2500.

The image object 2503 is displayed in the area near “CC university” on the map image so as to be superimposed, and has the third largest size among the image objects 2501 to 2503. That is, the image object 2503 represents that the congestion potential of the congestion which is likely to occur due to the currently parked vehicles 10 in the area near “CC university” is the third highest in the range corresponding to the map image included in the screen 2500.

The display aspect of the image objects is changed so as to correspond to the expected departure peak timings of the area corresponding to the image objects 2501 to 2503. That is, in the present example, the expected departure peak timings are expressed by the display aspect of the image objects 2501 to 2503.

For example, an aspect in which the image objects 2501 to 2503 are constantly turned on and off and the shorter a time needed for the expected departure peak timing, the shorter a cycle with which the image objects are turned on and off may be adopted.

The congestion prediction information providing unit 204 may specifically display the expected departure peak timing on the screen 2500 by using character information or the like through the display processing unit 202.

In addition to the image objects 2501 to 2503, the congestion potential (the degrees of congestion influence) of the areas corresponding to the image objects 2501 to 2503 are displayed in the right half area of the screen 2500 by using the number of star marks (“★”) (boxes 2504 to 2506). For example, an aspect in which one star mark may correspond to the degree of congestion influence of “1” may be adopted.

In a box 2504, the degree of congestion influence of the area near “AA dome” corresponding to the image object 2501 is represented by four star marks, and specifically, the degree of congestion influence caused by the vehicles 10 parked in the area is “4”.

In a box 2505, the degree of congestion influence of the area near “BB mall” corresponding to the image object 2502 is represented by two star marks, and specifically, the degree of congestion influence caused by the vehicles 10 parked in the area is “2”.

In a box 2506, the degree of congestion influence of the area near “CC university” corresponding to the image object 2503 is represented by one star mar, and specifically, the degree of congestion influence caused by the vehicles 10 parked in the area is “1”.

Arrow lines 2507 indicating the predicted congestion levels are displayed along the roads on the map image of the screen 2500 so as to be superimposed.

The arrow line 2507 may indicate the predicted congestion level in the expected passing timing when the user passes through the road link of the area. An aspect in which the arrow line 2507 changes the target timing corresponding to the predicted congestion level on a regular basis may be adopted. That is, the arrow line 2507 may be changed so as to indicate a predicted congestion level in a different target timing on a regular basis. In this case, for example, an aspect in which the arrow line 2507 represents a predicted congestion level in a time zone (timing) from a timing earlier than the expected passing timing by a predetermined time to a timing later than the expected passing timing by a predetermined time while switching the predicted congestion level for every predetermined cycle may be adopted. The arrow line 2507 may simply indicate the predicted congestion level after a predetermined time (for example, 30 minutes) defined in advance.

For example, any known method such as a method of changing the color of the arrow line depending on the magnitude of the predicted congestion level or a method of changing the thickness of the arrow line may be adopted as the display aspect of the predicted congestion level indicated by the arrow line 2507.

### Actions

As stated above, in the present embodiment, the congestion potential deriving unit 1210 derives the congestion potential indicating that the congestion may occur on the surrounding road in the future due to the vehicles 10 parked in a predetermined area (for example, any rectangular area indicated by the GeoHash value) based on the vehicle information (for example, the ACC-OFF information, the ACC-ON information, the positional information of the vehicle 10, and the like) regarding the movement states of the vehicles 10. The information distributing unit 1214 notifies the user of the information regarding the congestion potential through a notification unit provided in the vehicle 10.

As stated above, the center server 100 can ascertain the movement states of the vehicles 10 from the vehicle information obtained from the vehicles 10. Thus, it is possible to ascertain the vehicles 10 parked in a predetermined area by monitoring that there are the vehicles 10 parked in the area more than usual. The center server 100 can derive risk potential (congestion potential) indicating that the congestion is likely to occur on the surrounding road when the vehicles 10 (that is, the parked vehicles 10) staying within the area enter the road in the future. Accordingly, the center server 100 can notify the user of the information regarding the congestion potential as the information regarding the future congestion which is likely to occur due to the parked vehicles 10 through the notification unit of the vehicle 10.

Although it has been described in the present embodiment that the center server 100 directly monitors the parked vehicles 10 based on the vehicle information, an aspect in which the parked vehicles within the area may be indirectly ascertained and the congestion potential is derived by determining that the number of vehicles 10 entering a predetermined area is considerably smaller than the number of vehicles 10 leaving the area based on the vehicle information such as the time-series histories of the positional information of the vehicles 10 may be adopted.

In the present embodiment, the information distributing unit 1214 causes the display 70 to display the information regarding the congestion potential.

As stated above, the center server 100 can notify the user of the information regarding the congestion potential through the display 70 mounted on the vehicle 10.

Although it has been described in the present embodiment that the congestion potential is notified to the user of the vehicle 10 by displaying the information regarding the congestion potential on the display 70, the information regarding the congestion potential may be notified through another notification unit such as a sound output device in addition to or instead of the display 70.

In the present embodiment, the information distributing unit 1214 causes the display 70 to display the map image, and causes the display to display the image objects 2501 to 2503 having the sizes corresponding to the magnitudes of the congestion potential in the positions of the map image corresponding to the areas in which the congestion potential is present so as to be superimposed.

As mentioned above, the center server 100 can allow the user of the vehicle 10 to easily ascertain the specific position of the area having high congestion potential to some extent and the degree of congestion potential by the positions and sizes of the image objects 2501 to 2503 on the map image.

In the present embodiment, the communication processing unit 1201 obtains parking position information (specifically, the positional information included in the probe information including the ACC-OFF information) regarding the positions when the vehicles 10 are parked as the vehicle information regarding the movement states. The congestion potential deriving unit 1210 derives the congestion potential based on the number (the number of parked vehicles) of vehicles 10 parked within the target area among the vehicles 10, which is calculated based on the parking position information.

As mentioned above, the center server 100 can ascertain the number of vehicles 10 that are likely to enter the surrounding road of the area in the future by calculating the number of vehicles 10 parked within the target area from the parking position information of the vehicles 10. Accordingly, the center server 100 can specifically derive the congestion potential indicating that the congestion is likely to occur on the surrounding road of the area when the currently parked vehicles 10 enter the road from the number of vehicles 10 parked within the area.

In the present embodiment, the parking time analyzing unit 1205 obtains the parking time information regarding the time during which each vehicle 10 is parked. The departure timing predicting unit 1208 predicts a departure timing (expected departure timing) for each vehicle 10 parked in the target area among the vehicles 10 based on the history of the parking time information for each vehicle 10. The departure peak predicting unit 1211 predicts the timing (expected departure peak timing) when the congestion is to occur depending on the congestion potential based on the departure timing predicted by the departure timing predicting unit 1208. The information distributing unit 1214 notifies the user of the information regarding the timing when the congestion occurs, which is predicted by the departure peak predicting unit 1211, through the display 70 of the vehicle 10.

As stated above, the center server 100 can predict the current parking time of each vehicle 10 staying within the target area, that is, the departure timing from the history of the parking time information for each vehicle 10. The center server 100 can predict a timing when each parked vehicle 10 enters the road from the predicted departure timing of the parked vehicle 10. Accordingly, the center server 100 can predict a timing when the congestion is to occur depending on the congestion potential by specifying a timing when the vehicles 10 parked in the area intensively enter the road, and can notify the user of the predicted timing together with the derived congestion potential through the display 70 of the vehicle 10.

In the present embodiment, the departure timing predicting unit 1208 predicts the departure timing (expected departure timing) for each vehicle 10 parked in the target area among the vehicles 10 based on the history of the parking time information regarding the time during which the vehicle is parked when the vehicle visits the POI belonging to the same genre as that of the POI corresponding to the target area for each vehicle 10. Specifically, the departure timing predicting unit 1208 predicts the departure timing for each vehicle 10 parked in the target area based on the average parking time for each vehicle 10 corresponding to the same genre as that of the POI of the target area, which is stored in the parking time information DB 1200G

As stated above, the center server 100 uses the history of the parking time information when the vehicles 10 have different parking times from each other depending on genres of locations to visit but visit the POI having the same genre as that of the POI corresponding to the target area. Accordingly, since the center server 100 can predict the departure timing of each vehicle 10 parked within the area with higher precision, the center server can consequently predict the timing when the congestion is to occur depending on the congestion potential with high precision.

In the present embodiment, the usual congestion situation analyzing unit 1203 obtains the usual congestion information regarding the usual congestion situation. The predicted congestion level deriving unit 1212 predicts the congestion level (predicted congestion level) of the congestion which is likely to occur depending on the congestion potential based on the usual congestion information and the congestion potential. The information distributing unit 1214 may notify the user of the congestion level predicted by the predicted congestion level deriving unit 1212.

As stated above, the center server 100 can predict the congestion level (predicted congestion level) of the congestion which is likely to occur in the target area and on the surrounding road of the area by adding the degree of influence (the degree of congestion influence) depending on the congestion potential to the usual congestion situation based on the usual congestion information. Accordingly, the center server 100 can specifically notify the user of the congestion level of the congestion which is likely to occur depending on the congestion potential through the display 70 of the vehicle 10, in addition to the congestion potential.

In the present embodiment, the communication processing unit 1201 obtains (receives) the movement history information regarding the history of the positional information and the timing information in accordance with the movement of each vehicle 10, that is, the probe information transmitted from the vehicle 10 to the center server 100 on a regular basis. The usual congestion situation analyzing unit 1203 obtains the usual congestion information based on the movement history information.

As stated above, the center server 100 can ascertain the usual congestion situation of the road through which each vehicle 10 passes and can obtain the usual congestion information by ascertaining the passing time or the average vehicle speed when the vehicle passes through the road based on the movement history information.

In the present embodiment, the route information obtaining unit 1213 obtains the information (route information) regarding the route to the destination of the vehicle 10 on which the user rides. When the area (that is, the area in which the degree of congestion influence is equal to or greater than the predetermined reference) in which the congestion potential is relatively high is included in the areas on the route or the areas adjacent to the route, the information distributing unit 1214 notifies the user of the information regarding the congestion potential of the area through the display 70 of the vehicle 10 irrespective of whether or not the request from the vehicle 10 is received.

As mentioned above, when the area having relatively high congestion potential is included in the areas on the route of the vehicle 10 on which the user rides or the areas adjacent to the route, the user can be provided with the information regarding the congestion potential of the area with no request. Accordingly, it is possible to improve user convenience.

In the present embodiment, the center server 100 may derive solely a part of the congestion potential, the timing (expected departure peak timing) when the congestion is to occur depending on the congestion potential, the congestion level (predicted congestion level) of the congestion which is likely to occur depending on the congestion potential. For example, the center server 100 may derive solely the congestion potential, or may derive solely the congestion potential information and the expected departure peak timing. In the present embodiment, solely a part of the congestion potential, the expected departure peak timing, and the predicted congestion level may be notified to the user through the display 70.

Although the embodiment for implementing the disclosure has been described, the disclosure is not limited to the above-described specific embodiment, and may be variously changed and modified without departing from the gist of the disclosure described the claims.

For example, in the embodiment, the congestion prediction information providing unit 204 may transmit the congestion prediction information distributing request to the center server 100 irrespective of whether or not the route is set by the navigation unit 203. Specifically, the congestion prediction information providing unit 204 may transmit the congestion prediction information distributing request for requesting that the congestion prediction information in any position range that may be set by the predetermined operation is distributed to the center server 100 in response to the predetermined operation of the user. As described above, the congestion prediction information providing unit 204 can provide the user with the congestion prediction information regarding the position range requested by the user irrespective of whether or not the route is set.

For example, although it has been described in the embodiment that the vehicle as the distributing target of the congestion prediction information, that is, the congestion potential information and the predicted congestion level information is the same as the vehicle as the collecting target of the probe information (vehicle 10), these vehicles may be different from each other. That is, the congestion prediction information may be distributed to a vehicle other than the vehicles 10.

For example, although it has been described in the present embodiment that the distributing target of the congestion prediction information is the vehicle 10, the vehicle may be a portable terminal of the user of the vehicle 10, such as a mobile phone, a smartphone, or a mobile terminal. In this case the portable terminal as the distributing target of the congestion prediction information has the same functions as those of the storage unit 200, the display processing unit 202, the navigation unit 203, and the congestion prediction information providing unit 204 of the vehicle 10 (ECU 20).

What is claimed is:

1. An information notification apparatus comprising:
a vehicle information obtaining unit configured to obtain vehicle information regarding movement states of a plurality of vehicles;
a congestion potential deriving unit configured to derive congestion potential indicating that congestion is likely to occur on a surrounding road in the future due to vehicles parked in a predetermined area based on the vehicle information; and
a controller configured to notify a user of information regarding the congestion potential through a notification unit provided in a portable terminal or a target vehicle.

2. The information notification apparatus according to claim 1, wherein the controller displays the information regarding the congestion potential on a display device as the notification unit.

3. The information notification apparatus according to claim 2, wherein the controller displays a map image on the display device, and displays an image object having a size corresponding to a magnitude of the congestion potential in a position of the map image corresponding to the area having the congestion potential so as to superimpose the image object on the map image.

4. The information notification apparatus according to claim 1, wherein:
the vehicle information obtaining unit obtains parking position information regarding a position when each of the vehicles is parked, as the vehicle information; and
the congestion potential deriving unit derives the congestion potential based on the number of vehicles parked within the area, among the vehicles, which is calculated based on the parking position information.

5. The information notification apparatus according to claim 4, further comprising:
a parking time information obtaining unit configured to obtain parking time information regarding a time during which each of the vehicles is parked;
a departure timing predicting unit configured to predict a departure timing for each vehicle parked in the area, among the vehicles, based on a history of the parking time information; and
a congestion occurrence timing predicting unit configured to predict a timing when the congestion is to occur depending on the congestion potential based on the departure timing predicted by the departure timing predicting unit,
wherein the controller notifies the user of information regarding the timing when the congestion is to occur, which is predicted by the congestion occurrence timing predicting unit, through the notification unit.

6. The information notification apparatus according to claim 5, wherein the departure timing predicting unit predicts the departure timing for each vehicle parked in the area, among the vehicles, based on the history of the parking time information regarding the time during which the vehicle is parked when the vehicle visits a point of interest belonging to the same genre as a genre of a point of interest corresponding to the area for each of the vehicles.

7. The information notification apparatus according to claim 1, further comprising:
a usual congestion information obtaining unit configured to obtain usual congestion information regarding a usual congestion situation; and
a congestion level predicting unit configured to predict a congestion level of the congestion that is likely to occur depending on the congestion potential based on the usual congestion information and the congestion potential,
wherein the controller notifies the user of the congestion level predicted by the congestion level predicting unit through the notification unit.

8. The information notification apparatus according to claim 7, further comprising a movement history information obtaining unit configured to obtain movement history information regarding a history of positional information and timing information in accordance with movement of each of the vehicles,
wherein the usual congestion information obtaining unit obtains the usual congestion information based on the movement history information.

9. The information notification apparatus according to claim 1, further comprising a route information obtaining unit configured to obtain information regarding a route to a destination of the vehicle on which the user rides,
wherein the controller notifies the user of the information regarding the congestion potential of the area through the notification unit irrespective of whether or not a request from the portable terminal or the target vehicle is received when the area having relatively high congestion potential is included in areas on the route or areas adjacent to the route.

10. An information notification system that includes a server, and a portable terminal or a target vehicle connected to the server so as to communicate with each other, the information notification system comprising:
a vehicle information obtaining unit provided in the server, and configured to obtain vehicle information regarding movement states from a plurality of vehicles;
a congestion potential deriving unit provided in the server, and configured to derive congestion potential indicating that congestion is to occur on a surrounding road in the future due to vehicles parked in a predetermined area based on the vehicle information; and
a notification unit provided in the portable terminal or the target vehicle, and configured to notify a user of information regarding the congestion potential.

11. An information notification method performed by an information notification apparatus, the information notification method comprising:
obtaining vehicle information regarding movement states of a plurality of vehicles;
deriving congestion potential indicating that congestion is to occur on a surrounding road in the future due to vehicles parked in a predetermined area based on the vehicle information; and
notifying a user of information regarding the congestion potential through a notification unit provided in a portable terminal or a target vehicle.

12. An information notification program causing a computer to perform:
a vehicle information obtaining step of obtaining vehicle information regarding movement states of a plurality of vehicles;
a congestion potential deriving step of deriving congestion potential indicating that congestion is to occur on a surrounding road in the future due to vehicles parked in a predetermined area based on the vehicle information; and
a control step of notifying a user of information regarding the congestion potential through a notification unit provided in a portable terminal or a target vehicle.
